(19) United States
(12) Patent Application Publication
(10) Pub. No.: US 2009/0319491 A1
(43) Pub. Date: Dec. 24, 2009

(54) INFORMATION PROCESSING APPARATUS, INFORMATION PROCESSING SYSTEM, AND INFORMATION PROCESSING METHOD

(75) Inventors: Masato AKAO, Kanagawa (JP); Tetsujiro Kondo, Tokyo (JP); Kazutaka Ando, Kanagawa (JP); Yoshihito Fujiwara, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/476,814

(22) Filed: Jun. 2, 2009

(30) Foreign Application Priority Data
Jun. 18, 2008 (JP) 2008-159727

(51) Int. Cl. G06F 7/06; G06F 17/30

(52) U.S. Cl. 707/3; 707/102; 707/E17.014; 707/E17.044

(57) ABSTRACT

An information processing apparatus includes a pattern extraction unit configured to extract operation patterns from operation history information at least including an operation history of a user and information on a device state obtained from a plurality of operation target devices, a defined pattern database configured to previously register a defined pattern which is a pattern of a combination of defined operations in accordance with the operation target devices, a rule extraction unit configured to extract an unexpected operation pattern from the operation patterns extracted by the pattern extraction unit with reference to the defined pattern database, and a reflection information generation unit configured to generate reflection information to be reflected on a function of the operation target devices from the unexpected operation pattern.

### BACKGROUND OF THE INVENTION

1. Field of the Invention

The present invention relates, for example, to an information processing apparatus, an information processing system, and an information processing method with which a new function of an operation target device can be provided by utilizing history information on an unexpected operation of an arbitrary user.

2. Description of the Related Art

In recent years, in response to an increased audio visual (AV) attentiveness, AV devices having a still higher function have been developed. In particular, television receivers and the like have a function of allowing a user to perform various image processings for selecting a preference of an image (an image quality including hue and vividness of the image) on the basis of a user setting. By utilizing operation history information with respect to the device such as the selection for the preference of the image, a service is offered for a marketing research such as an analysis on a user preference or a content recommendation.

For example, a system configured to provide a service such as an automatic control of the device or information provision by utilizing an operation history of an arbitrary user on a device has been proposed (see US2006053219 (Japanese corresponding application: Japanese Unexamined Patent Application Publication No. 2004-185612)).

Also, an operation supporting apparatus has been proposed which is configured to estimate a user's purpose on the basis of a content related to an operation performed on the device and reflect the information on a user interface for supporting the user operation (see Japanese Unexamined Patent Application Publication No. 08-171443).

### SUMMARY OF THE INVENTION

Incidentally, the system described in US2006053219 performs the analysis concentrating on frequently appearing operation patterns of the user and mainly extracts so-called “expected operations”. That is, the system does not reflect the finding from the information analysis result on the device upgrade or the like.

Also, the apparatus described in Japanese Unexamined Patent Application Publication No. 08-171443 basically relates to a technology of “self tuning (learning)” by previously preparing an operation supporting mechanism with which the user is guided to a normal operation if a sign of an erroneous operation appears. That is, the apparatus does not place priority on “unexpected operation information”, which is not previously prepared. Also, the apparatus is used for preventing the erroneous operation of the user using the device, which lacks “individually specialized” elements.

Furthermore, as described above, as various processing mechanisms are incorporated in the AV device, a large number of functions and services can be provided. However, functions selected in consideration of costs and the like by a manufacturer side are only mounted to a final product to be provided on the user side, and the functions are limited in a package unit. For that reason, even when the upgrade on only a particular function among the set is desired, the user ought to purchase the whole set again. Also, according to the above-described technologies in the related art, the information on which image quality or sound quality the user prefers is not obtained and analyzed, and there is a problem that it is difficult to provide a function or a product matching with a preference of an individual user.

The present invention has been made in view of the above-described circumstance, and it is desirable to provide an information processing apparatus, an information processing system, and an information processing method with which a new demand (new function) of a user can be found out on the basis of an operation history, a state of a device, and the like.

According to an embodiment of the present invention, there is provided an information processing apparatus including: a pattern extraction unit configured to extract operation patterns from operation history information at least including an operation history of a user and information on a device state obtained from a plurality of operation target devices; a defined pattern database configured to previously register a defined pattern which is a pattern of a combination of defined operations in accordance with the operation target devices; a rule extraction unit configured to extract an unexpected operation pattern from the operation patterns extracted by the pattern extraction unit with reference to the defined pattern database; and a reflection information generation unit configured to generate reflection information to be reflected on a function of the operation target devices from the unexpected operation pattern.

According to an embodiment of the present invention, there is provided an information processing apparatus including: a pattern extraction unit configured to extract an operation pattern from an operation history on the information processing apparatus by a user; an unexpected operation pattern extraction unit configured to extract an unexpected operation pattern from the operation pattern extracted by the pattern extraction unit with reference to a defined pattern which is a pattern of a combination of defined operations on the information processing apparatus; and a reflection information generation unit configured to generate reflection information to be reflected on a function of the information processing apparatus from the unexpected operation pattern.

According to an embodiment of the present invention, there is provided an information processing system including: operation target devices each including an input unit to which an operation signal based on an operation by a user is input, a signal processing unit configured to process an input signal on the basis of the operation signal which is input to the input unit, and a history saving unit configured to store an operation history of the user and a device state after the input signal is processed, as operation history information; and an information processing apparatus including a pattern extraction unit configured to extract operation patterns from the operation history information at least including the operation history of the user and information on the device state obtained from the operation target devices, a defined pattern database configured to previously register a defined pattern which is a pattern of a combination of defined operations in accordance with the operation target devices, a rule extraction unit configured to extract an unexpected operation pattern from the operation patterns extracted by the pattern extraction unit with reference to the defined pattern database, and a reflection information generation unit configured to generate reflection information to be reflected on a function of the operation target devices from the unexpected operation pattern.

According to an embodiment of the present invention, there is provided an information processing method including the steps of: obtaining operation history information at least including an operation history of a user and information on a device state obtained from a plurality of operation target devices; extracting operation patterns from the operation history information; extracting an unexpected operation pattern from the extracted operation patterns with reference to a defined pattern database previously registering a pattern of a combination of defined operations in accordance with the operation target devices; and generating reflection information to be reflected on a function of the operation target devices from the unexpected operation pattern.

According to the embodiment of the present invention, the operation pattern is extracted from the obtained operation history information. Then, with reference to the defined pattern database previously registering the pattern of the combination of the defined operations in accordance with the operation target devices, the unexpected operation pattern is extracted from the extracted operation patterns. With this configuration, the unexpected operation pattern (rule) which is not originally recognized is extracted.

As described above, according to the embodiment of the present invention, from the operation history, the state of the device, and the like, it is possible to discover the new demand (new function) of the user. Accordingly, it is possible to introduce the new function which is not originally recognized to the operation target devices.

### BRIEF DESCRIPTION OF THE DRAWINGS

FIG. 1 shows an outline of an information processing system for developing a new function to which an embodiment of the present invention is applied;

FIG. 2 is an external appearance view of a remote controller according to an embodiment of the present invention;

FIG. 3 shows an example of an OSD menu supposed to be used according to an embodiment of the present invention;

FIG. 4 shows an example of a two screen display function supposed to be used according to an embodiment of the present invention;

FIG. 5 shows a configuration example of a system according to an embodiment of the present invention;

FIG. 6 shows an outline of a history collection section (user side apparatus) according to an embodiment of the present invention;

FIG. 7 shows an example of operation history information according to an embodiment of the present invention;

FIG. 8 is a flow chart for a processing example of the history collection section according to the embodiment of the present invention;

FIG. 9 is a block diagram of an internal configuration example of a history analysis section according to an embodiment of the present invention;

FIG. 10 is a flow chart for a processing example of a pre-processing unit according to an embodiment of the present invention;

FIG. 11 shows an example of pre-processed operation history information according to an embodiment of the present invention;

FIG. 12 is a flow chart for a processing example of a series operation extraction unit according to an embodiment of the present invention;

FIG. 13 shows an extraction example of a series of operations according to an embodiment of the present invention;

FIG. 14 is a flow chart for a processing example of an operation pattern extraction unit according to an embodiment of the present invention;

FIG. 15 is a flow chart for a processing example of a sequential rule extraction unit according to an embodiment of the present invention;

FIG. 16 is a flow chart for a processing example of a reflection information generation unit (higher layer) according to an embodiment of the present invention;

FIG. 17 shows an example of a combination function information table (higher layer) according to an embodiment of the present invention;

FIG. 18 shows an example of a reflection method table (higher layer) according to an embodiment of the present invention;

FIG. 19 shows an example of a reflection information table (higher layer) according to an embodiment of the present invention;

FIG. 20 shows an example of a reflection information table (higher layer) to which a time varying element is input;

FIG. 21 is a flow chart for a processing example of a reflection information generation unit (lower layer) according to an embodiment of the present invention;

FIG. 22 shows an example of a prohibition operation information table (higher layer) according to an embodiment of the present invention;

FIG. 23 shows an example of a reflection method table (lower layer) to which a time varying element is input;

FIG. 24 shows an example of a reflection information table (lower layer) to which a time varying element is input;

FIG. 25 is a block diagram of an internal configuration example of a television receiver to which a new function is applied;

FIG. 26 shows an upgrade example of an OSD menu (higher layer) according to an embodiment of the present invention;

FIG. 27 shows an example of a two screen mode image quality setting (higher layer) according to an embodiment of the present invention;

FIG. 28 shows an upgrade example of a two screen mode (lower layer) according to an embodiment of the present invention;

FIG. 29 shows an upgrade example in units of group according to an embodiment of the present invention;

FIG. 30 is a flow chart for an upgrade processing example in units of group according to an embodiment of the present invention; and

FIG. 31 is a block diagram of a configuration example of a general-use personal computer.

### DESCRIPTION OF THE PREFERRED EMBODIMENTS

Hereinafter, preferred embodiment examples for realizing the present invention will be described with reference to the attached drawings. The description will be given in order of the following items.

1. Outline of an information processing system according to an embodiment of the present invention

2. History collection section and a history analysis section (common part) according to an embodiment of the present invention

3. History analysis section (reflection generation unit: in the case of a higher layer) according to an embodiment of the present invention

4. History analysis section (reflection generation unit: in the case of a lower layer) according to an embodiment of the present invention

5. History reflection section according to an embodiment of the present invention

6. Upgrade (common, higher layer, lower layer)

7. Upgrade in units of group

8. Others

### 1. Outline of an Information Processing System According to an Embodiment of the Present Invention

An embodiment of the present invention relates to an analysis method for recording data such as an operation history of a user and a device state, and regarding the technology described in US 2008209463 (corresponding Japanese application: Japanese Unexamined Patent Application Publication No. 2004-265399), in particular, the information analysis section and the like on the center processing apparatus, the above-mentioned analysis method is embodied from the viewpoint of the operation system.

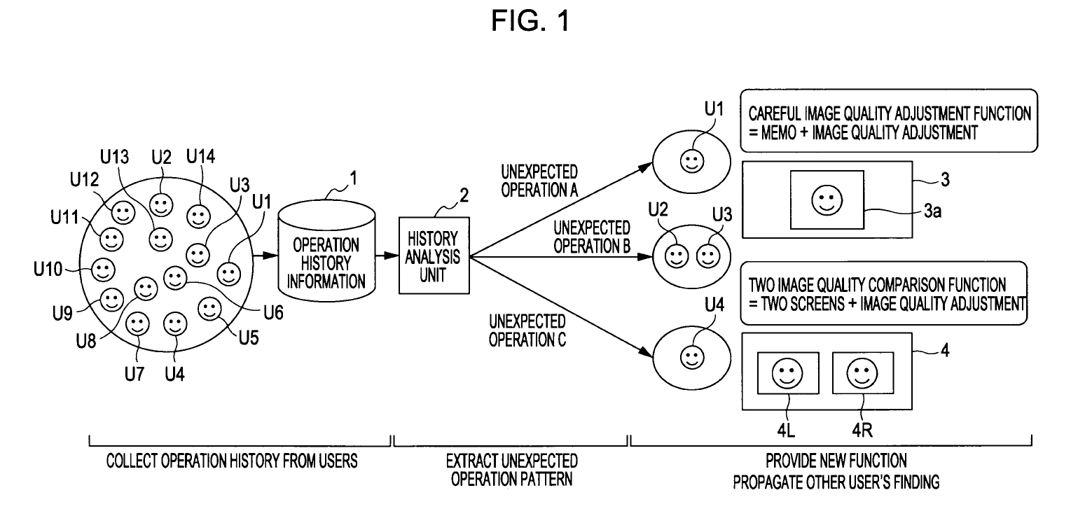

FIG. 1 shows an outline of an information processing system to which an embodiment of the present invention is applied.

The information processing system to which the embodiment of the present invention is applied collects operation history information 1 on operations performed on devices by a plurality of users U1 to U14. The collected operation history information 1 is analyzed by a history analysis unit 2 to extract unexpected operation patterns including unexpected operation patterns A to C. Then, the unexpected operation patterns A to C extracted by the history analysis unit 2 are provided to the users U1 to U4 as new functions. It should be noted that in this example, the description is given that the operation history information is collected from the 14 users, but more users (devices) exist in actuality.

With this configuration, a new function found by a user can be propagated to other users. Also, without causing burden on the users, it is possible to (unconsciously) obtain the operation history information. For example, a “careful image quality adjustment function” for adjusting the image quality of a screen 3a displayed on a display screen 3 of a television receiver, an “image quality comparison function” for comparing the image qualities of screens 4L and 4R displayed on a display screen 4, and the like can be newly provided. Examples of the new functions which can be provided to the users will be described below.

It should be noted that according to the following embodiments, a television set is supposed to be used as a use device on the user side, but is not limited to this. The embodiments can be applied to an electronic device configured to collect different pieces of operation history information depending on use environments when the user operations are input and the internal states of the devices are characteristically changed, for example.

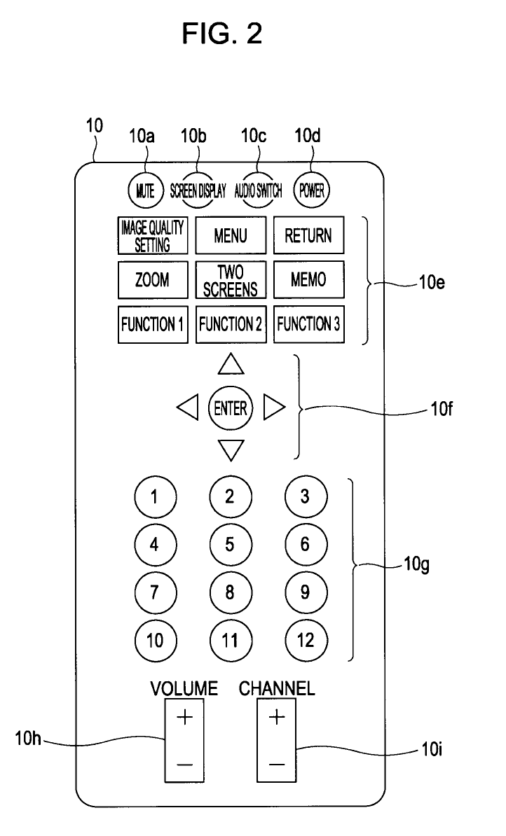

FIG. 2 shows an example of a remote controller supposed to be used in the following description.

A remote controller 10 shown in FIG. 2 includes, for a key input unit, for example, a mute button 10a, a screen display button lob, a sound switch button 10c, a power button 10d, an image quality setting button group 10e, a direction button group 10f, a ten-key 10g, a volume adjustment button 10h, a channel selection button 10i, and the like.

Furthermore, the image quality setting button group 10e is composed of “image quality setting button”, “menu button”, “return button”, “zoom button”, “two screen button”, “memo button”, “function 1 button”, “function 2 button”, and “function 3 button”. It should be noted that “memo” is a (simplified capture) function for pausing a video displayed on the screen. Also, “function 1 to 3 buttons” are respectively spare buttons for allocating macro commands at the time of upgrade. Also, the direction button group 10f is composed of up, down, left, and right direction buttons, and an enter key is arranged at the center of the four direction buttons.

It should be noted that the type, the arrangement, and the like of the buttons shown in FIG. 2 are examples and not limited to these examples. For example, a button arrangement surface of the remote controller 10 is configured as a touch panel, and a desired operation may also be performed by touching an icon (button) displayed on the panel.

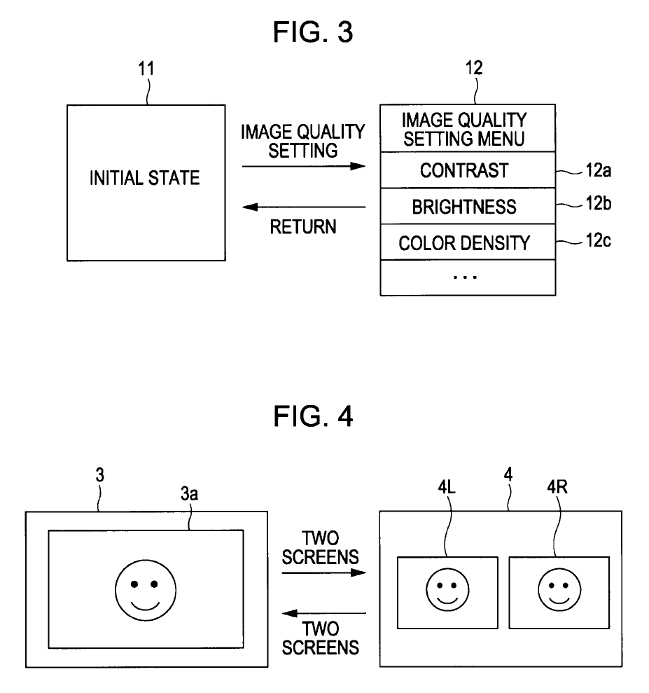

FIG. 3 shows an example of OSD (On Screen Display) menu supposed to be used in the following description.

For example, when the image quality setting button of the remote controller 10 is pressed at the time of the initial state 11, a control signal from the remote controller 10 is received, and a state is established in which an image quality setting menu 12 is displayed as a OSD menu. The image quality setting menu 12 has a format in which a pull down menu is displayed for a lower hierarchy thereof. For example, setting items including contrast 12a, brightness 12b, color density 12c, and the like are prepared. On the other hand, while the image quality setting menu is displayed, if a return button is pressed, the state is returned to the initial state. The OSD menu shown in FIG. 3 is an example, and a detail of which will be described below.

FIG. 4 shows an example of a two screen display function supposed to be used in the following description.

For example, in the single screen display state where the screen 3a is displayed on the display screen 3, the two screen button of the remote controller 10 is pressed, the screen is switched to the two screen display state in which the screens 4L and 4R displayed on the display screen 4. On the other hand, at the time of the two screen display state, when the two screen button is pressed, the screen is returned from the display screen 4 to the display screen 3 in the single screen display state. The display switching shown in FIG. 4 is an example, and a detail of which will be described below.

### 2. History Collection Section and a History Analysis Section According to an Embodiment of the Present Invention (Common Part)

Next, a common part according to an embodiment of the present invention will be described. The common part refers to a common configuration and operation for processing a higher layer and a lower layer derived from the operation history information.

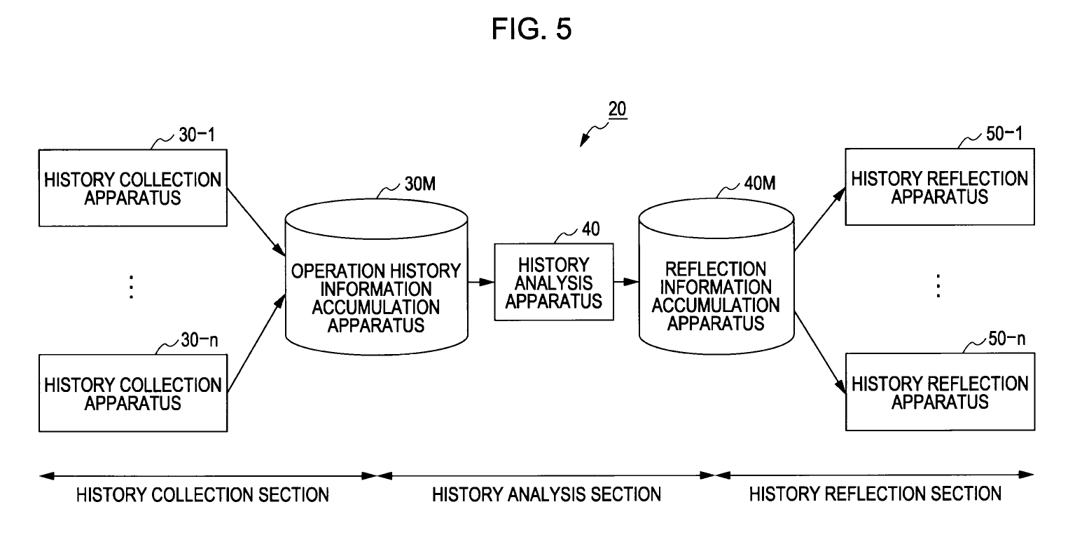

FIG. 5 shows a configuration example of an information processing system according to an embodiment of the present invention.

An information processing system 20 according to the present embodiment is roughly composed of a history collection section including history collection apparatuses 30-1 to 30-n, a history analysis section including a history analysis apparatus 40, and a history reflection section including history reflection apparatuses 50-1 to 50-n. In general, the history collection section and the history reflection section are the same component, but are not limited to the same component.

The history collection section is installed on a user side (for example, a house, a work place, or the like). When the user utilizes the device, the information (for example, an operation history of the user, an input signal, a state of the device, and the like) is accumulated. The respective history collection apparatuses 30-1 to 30-n constituting the history collection section may be stored inside the device such as a television receiver or may be configured as an individual component. Hereinafter, the history collection apparatuses 30-1 to 30-n will be referred to as history collection apparatus 30, and the history collection apparatus 30 represents each of the history collection apparatuses 30-1 to 30-n if not otherwise specified. Information accumulated in the respective history collection apparatuses 30, that is, operation history information, will be collected. It is conceivable that the collection method may be a method of obtaining the information via a network, a method of posting a recording medium on which the operation history information is recorded to a manufacturer side, and the like. A detail of the history collection apparatus 30 will be described below.

The history analysis section is, for example, a (server) apparatus installed at a center of a manufacturer which develops the product. The history analysis apparatus 40 constituting the history analysis section extracts and analyzes unexpected operations on the basis of records including the operation history, the state of the device, and the like on the basis of operation history information accumulation apparatus 30M configured to accumulate the operation history information sent from the history collection apparatuses 30-1 to 30-n of all the users. Then, useful information which can be used for the upgrade (reflection information) is extracted. The useful information which can be used for the upgrade is saved in a reflection information accumulation apparatus 40M. A detail of the history analysis apparatus 40 will be described below.

The history reflection section is installed on the user side (for example, the house, the work place, or the like). The history reflection apparatuses 50-1 to 50-n constituting the history reflection section upgrades the operation target device on the basis of the information related to the upgrade the reflection information accumulation apparatus 40M. For example, the device customized on the basis of the upgrade information is provided to the users, or the upgrade information is sent to the user side (via the network), and the function is customized on the device on the user side on the basis of the upgrade information. Hereinafter, the history reflection apparatuses 50-1 to 50-n will be collectively referred to as the history reflection apparatus 50, and the history reflection apparatus 50 represents each of the history reflection apparatuses 50-1 to 50-n if not otherwise specified. A detail of the history reflection apparatus 50 will be described below.

### Configuration of a History Collection Section

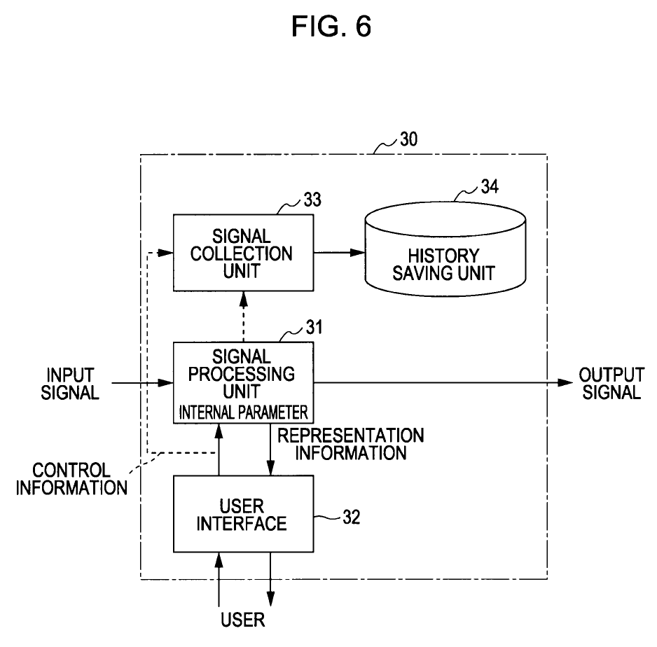

FIG. 6 shows a configuration example of the history collection section constituting the information processing system 20.

The history collection section is provided with the history collection apparatus 30, and the history collection apparatus 30 is configured by including a signal processing unit 31, the user interface (input unit, output unit) 32, a signal collection unit 33, and a history saving unit 34.

For the signal processing unit 31, a DSP (Digital Signal Processor), a CPU (Central Processing Unit), or the like is applied. The signal processing unit 31 supplies presentation information in which a predetermined processing is performed on an input signal (a video signal, an audio signal, or the like) to the user interface 32. Also, control information included in the signal which is input by the user by using the remote controller 10 (see FIG. 2) is received, and a processing based on the control information is performed.

The user interface 32 analyzes the signal which is input by the user by using the remote controller 10, and outputs control information which is a result of the analysis to the signal processing unit 31 and the signal collection unit 33. To be more specific, the user interface 32 is a graphical user interface. It should be noted that for the interface, a light reception unit configured to receive an infrared signal from the remote controller 10 is provided.

The signal collection unit 33 collects the control information input from the user interface (operation history) and the input signal and internal parameters (input signal, the device state, and the like) input from the signal processing unit 31.

The history saving unit 34 is composed of a magnetic recording apparatus, a semiconductor memory, or the like and configured to record and accumulate the information collected by the signal collection unit 33.

The history collection section configured in the above-mentioned manner collects the electric signals flowing inside the electronic device (such as the television receiver) used by the user by using the signal collection unit 33. In the following description, the record of the collected electric signals is collectively referred to as “operation history”, which represents the operation information itself of the user and the record of the change in the internal state due to the operation information.

For example, in the case of the television set, as shown in FIG. 6, the control information sent from the user interface (the display unit, the light reception unit, and the like of the display) 32 to the signal processing unit 31 and the internal parameters of the signal processing unit 31 are detected by the signal collection unit 33. The collected electric signals include communication data between any devices such as a infrared remote control (SIRCS: Serial Infrared Remote Control System) code, a code flowing through an I2C (Inter-Integrated Circuit) bus as the record of the internal state of the device, and an SCI (Serial Communication Interface) communication code, but are not limited to the above-mentioned information.

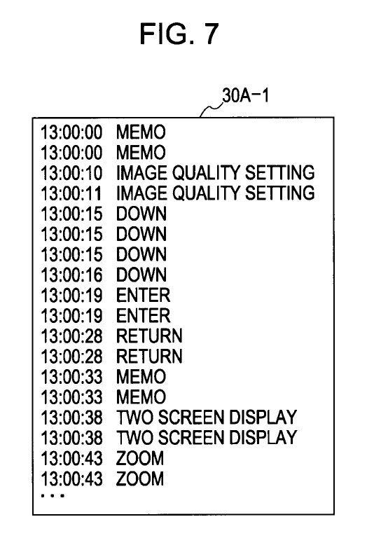

After the electric signals (the SIRCS code, the I2C code, and the like) are collected, operation history information 30A-1 is created by combining an obtainment time, a type of the remote control code, and the like shown in FIG. 7 to be saved in the history saving unit 34. Herein, any information can be exhaustively collected as the operation history information 30A-1, but for saving the recording area, filtering is performed so that only particularly useful operation history information is saved. By repeatedly performing the above-mentioned processing, the operation history information is accumulated in the history saving unit 34.

When the free area of the history saving unit 34 runs out, replacement of the history saving unit 34 is urged, and the manufacturer (center) collects the history saving unit 34. It is also conceivable that after a certain period of time since the use start of the device, the history saving unit 34 is collected in response to a request from the manufacturer (center). In order to collect the operation history information, an electronic device or a detachable history saving unit (a dedicated-use recording apparatus is prepared or mounted to the remote controller, or the like) may be provided by the user to the manufacturer side (center). In a case where a network connection function is provided to the electronic device, a method of sending the accumulated operation history information to the manufacturer side (center) via a network may also be adopted.

### Operation of the History Collection Section

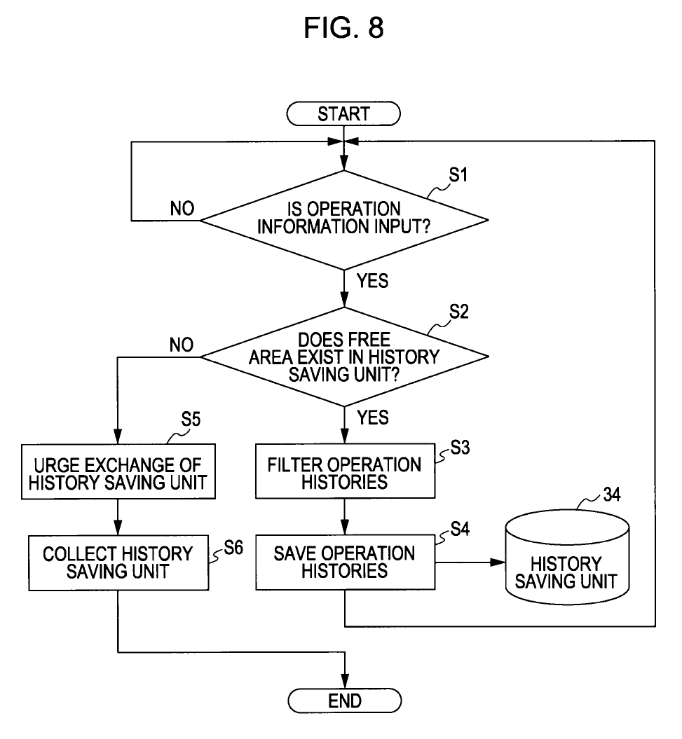

Next, with reference to a flow chart shown in FIG. 8, a processing example of the history collection section (the history collection apparatus 30) constituting the information processing system 20 will be described.

In step S1, when a collection processing of the operation history information is started, first, it is determined whether or not information on the operation by the user is input via the user interface 32 to the signal processing unit 31. In a case where the operation information is input, the process advances to the processing in step S2. On the other hand, in a case where the operation information is not input, the processing in step S1 is repeatedly executed to monitor the presence or absence of the input of the operation information.

In step S2, the signal collection unit 33 determines whether or not a free space exists in the history saving unit 34. In a case where the free space exists, the process advances to a processing in step S3. On the other hand, in a case where the free space does not exist, the process advances to a processing in step S5.

In step S3, the signal collection unit 33 filters the operation history information. That is, various information existing in the device is filtered and only the operation history information is saved. After this processing is ended, the process advances to a processing in step S4.

In step S4, the signal collection unit 33 saves the operation history information in the history saving unit 34. After this processing is ended, the process is returned to the determination processing in step S1, and the series of the processing is repeatedly performed.

Also, in step S5, in a case where it is determined that the free space does not exist in the history saving unit 34, a control is performed so that the signal processing unit 31 displays a message for urging the replacement of the history saving unit 34 on the user interface 32.

In step S6, the operation history information accumulated in the history saving unit 34 is sent to the manufacturer side (center) via the network. Alternatively, the user may provide the electronic device (the history collection apparatus 30) or the detachable history saving unit 34 to the manufacturer side (center).

### Configuration of the History Analysis Section

Next, the history analysis section configured to analyze the operation history information collected by the history collection section will be described.

In the following description, the processing of the history analysis section is individually performed by the respective users but, in particular, in a sequential rule extraction unit, at the time of comparison between the users or the like, a large effect is obtained if the data of as many of users as possible is comprehensively used to advance the process.

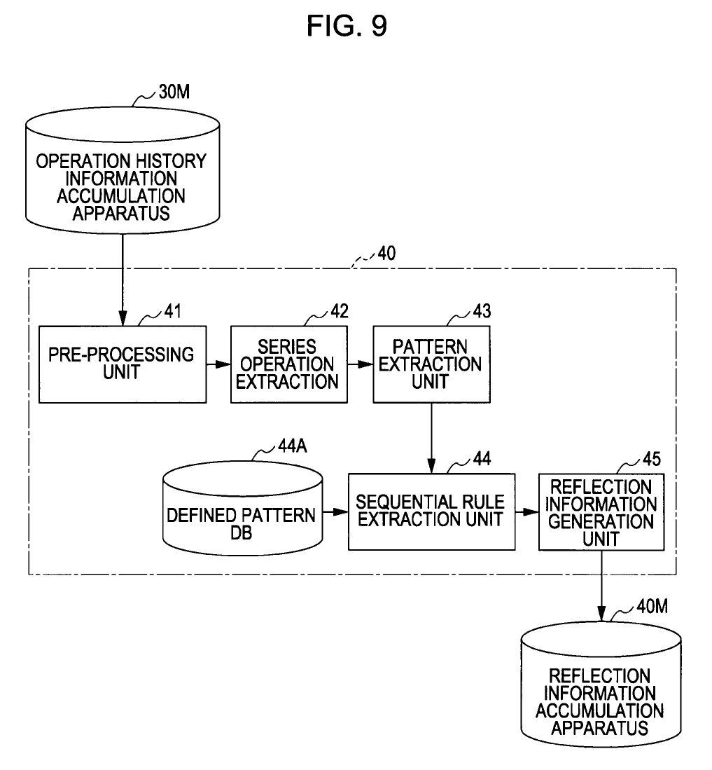

FIG. 9 shows a configuration example of the history analysis section constituting the information processing system 20.

The history analysis section is roughly composed of the operation history information accumulation apparatus 30M, the history analysis apparatus 40, and the reflection information accumulation apparatus 40M. For the operation history information accumulation apparatus 30M and the reflection information accumulation apparatus 40M, a magnetic recording apparatus or a non-volatile recording unit such as a semiconductor memory can be applied.

The history analysis apparatus 40 is configured by including a pre-processing unit 41, a series operation extraction unit 42, a pattern extraction unit 43, a sequential rule extraction unit 44, and a reflection information generation unit 45. For the respective units of the history analysis apparatus 40, for example, a signal processing apparatus such as a CPU is applied, which performs a predetermined processing on an input signal and outputs the signal to a processing unit in the next stage. It should be noted that the history analysis apparatus 40 is provided with a memory which is not shown in the drawing. Alternatively, in the respective units of the history analysis apparatus 40, a memory for storing a result of a processing or computation by the respective units may be individually provided.

The pre-processing unit 41 can obtain many types of the operation history information depending on a specification of the operation history information recorded in the operation history information accumulation apparatus 30M, but the pre-processing unit 41 only extracts information used for an analysis to be carried out from the operation history information accumulation apparatus 30M and adjusts a format (data format) of the operation history information. A detail of this operation by the pre-processing unit 41 will be described below.

The series operation extraction unit 42 is configured to extract a block (series operation) of the operation history information which can be estimated to have the same purpose on the basis of the long-term operation history information pre-processed by the pre-processing unit 41. A detail of this operation by the series operation extraction unit 42 will be described below.

The pattern extraction unit 43 extracts operation patterns from the respective series operations extracted by the series operation extraction unit 42 for adding up. A detail of this operation by the pattern extraction unit 43 will be described below.

The sequential rule extraction unit 44 refers to a defined pattern database 44A with regard to the respective operation patterns extracted by the pattern extraction unit to create meaning and extract information (new function) which can be utilized for the upgrade. A detail of this operation by the sequential rule extraction unit 44 will be described below.

In the defined pattern database 44A, operation patterns are registered which are defined operation patterns (defined patterns) previously mounted in the device, whose description is in an operating manual, and also which are executed by a defined operation procedure. The defined pattern database 44A is constructed in a non-volatile memory. It should be noted that in the following description, the defined pattern database 44A is referred to as “the defined pattern DB 44A”.

The reflection information generation unit 45 generates the information which can be utilized for the upgrade extracted by the sequential rule extraction unit 44, that is, the reflection information for reflecting the new function to the device from the reflection method or the like on how to reflect the unexpected operation patterns and the respective operations according to the present embodiment. The reflection information is saved in the reflection information accumulation apparatus 40M. A detail of this operation by the reflection information generation unit 45 will be described below.

### Operations of the Respective Units of the History Analysis Section

Next, processing examples of the respective units of the history analysis section (the history analysis apparatus 40) constituting the information processing system 20 will be described.

### Operation of the Pre-Processing Unit

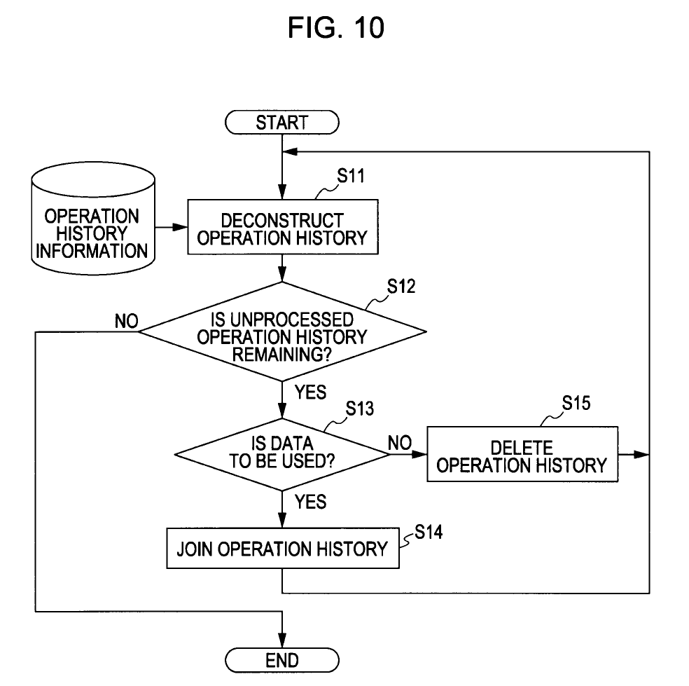

With reference to a flow chart shown in FIG. 10, a processing example of the pre-processing unit 41 will be described.

In step S11 (operation history deconstruction processing), when the pre-processing is started, first, the operation history information (see FIG. 7) collected in the operation history information accumulation apparatus 30M is deconstructed for each operation history code, and for each operation history code, the operation history information is sequentially sent to a determination processing in the next step S12.

In step S12 (operation history remaining number determination processing), it is determined whether or not the unprocessed operation history information (operation history code) is remaining. When the unprocessed operation history information is remaining, the process advances to a determination processing in step S13, and when the unprocessed operation history information is not remaining, the pre-processing is ended.

In step S13 (operation history type determination processing), it is determined whether or not the information is the operation history information (operation history code) used in the analysis to be carried out. The operation history information to be used is only extracted, and the process advances to the processing in the next step S14. The remaining unused operation history information is sent to a processing in step S15. It should be noted that the operation history information is narrowed down also in an operation pattern narrowing down processing of the sequential rule extraction unit 44, and therefore narrowing down may not be carried out in this stage.

A specific example for converting the collected operation history information into data to be utilized for the analysis includes a processing for removing overlapping operation history codes from the SIRCS codes, for example. In general, for stability of a communication, once a button is pressed, a plurality of (two in the following example) SIRCS commands are sent, and therefore the overlapping excess operation history codes are removed. Also, in another example, the operation history codes which are not used for the analysis are removed. For example, in a case where an analysis on a menu operation is performed, the irrelevant operation history information (such as a processing code in the device) is removed. Also, for example, when only the operation history information related to the channel selection is to be used, other operation history information (such as volume adjustment and image quality adjustment) is removed.

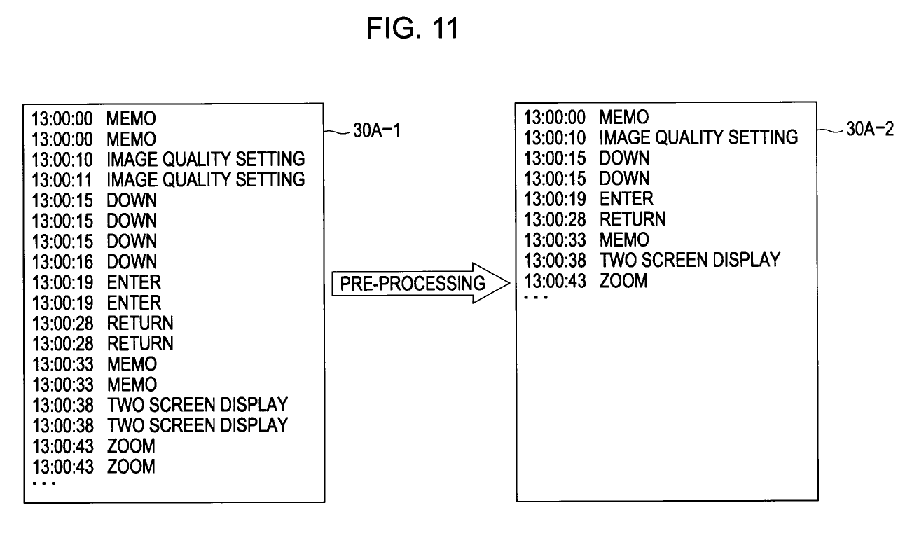

The example of the pre-processed operation history information is shown in FIG. 11. The example shown in FIG. 11 is an example in which the pre-processing is performed on the operation history information 30A-1 to obtain operation history information 30A-2 from which the overlapping operation history codes are removed.

The description is returned to the explanation on the flow chart of FIG. 10. In step S14 (operation history joining processing), the one operation history code on which the operation history type determination processing in step S13 is performed is joined to the operation history code group. After this processing is ended, the process advances to the processing in step S11, and the process is repeatedly performed until the processing for all the operation history codes is ended.

In step S15 (operation history removal unit), in a case where it is determined in step S13 that the operation history information is not used for the analysis, the relevant operation history information (operation history code) is removed. After this processing is ended, the process advances to the processing in step S1, and the process is repeatedly performed until the processing for all the operation history codes is ended.

### Operation of Series Operation Extraction

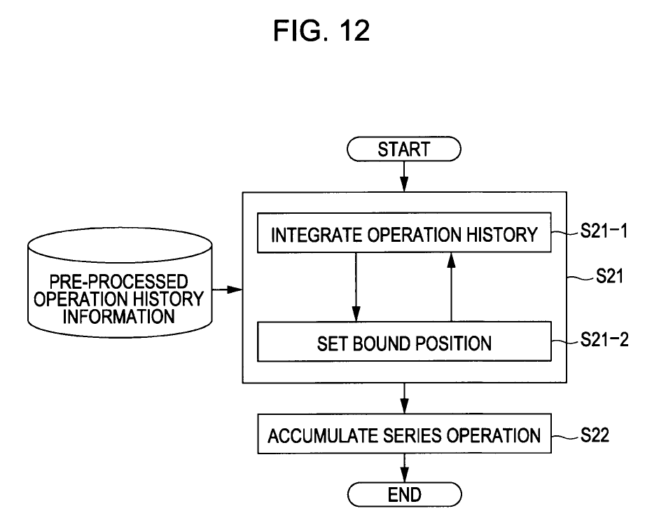

With reference to a flow chart shown in FIG. 12, a processing example of the series operation extraction unit 42 will be described.

In step S21, when the operation extraction processing is started, first, in the pre-processing unit 41, the series operation extraction processing is performed on the pre-processed operation history information. In the series operation extraction processing, an operation history integration processing (step S21-1) and/or a bound position setting processing (step S21-2) is performed. Alternatively, these processings are repeatedly performed back and forth. After this processing is ended, the process advances to the processing in step S22.

In step S21-1 (operation history integration processing), the adjacent pieces of pre-processed operation history information (operation history code) or the pieces of pre-processed operation history information existing sufficiently close to each other are integrated while following various rules. For the rules, for example, the following items are used in combination.

(1) Generation time: the operation history codes at the same time are regarded as the same to be integrated.
(2) Type of the operation history codes: the operation history codes having the same type are integrated.

In the case of (2), for example, in the television set, various integration methods can be selected while a designing is carried out in accordance with demands such as integration of only a “volume up” code and integration of the “volume up” code and a “volume down” code while being regarded as the same.

Also, for the combination of the rules used for the integration, for example, various integration methods can be selected in accordance with needs, for example, the operation history codes at the same time and the same type of the operation history codes are integrated first, and thereafter the integration is further carried out in accordance with the types of the integrated operation history codes. In a case where such an integration is carried out, the processing in step S21-1 and the processing in step S21-2 are repeatedly performed back and forth.

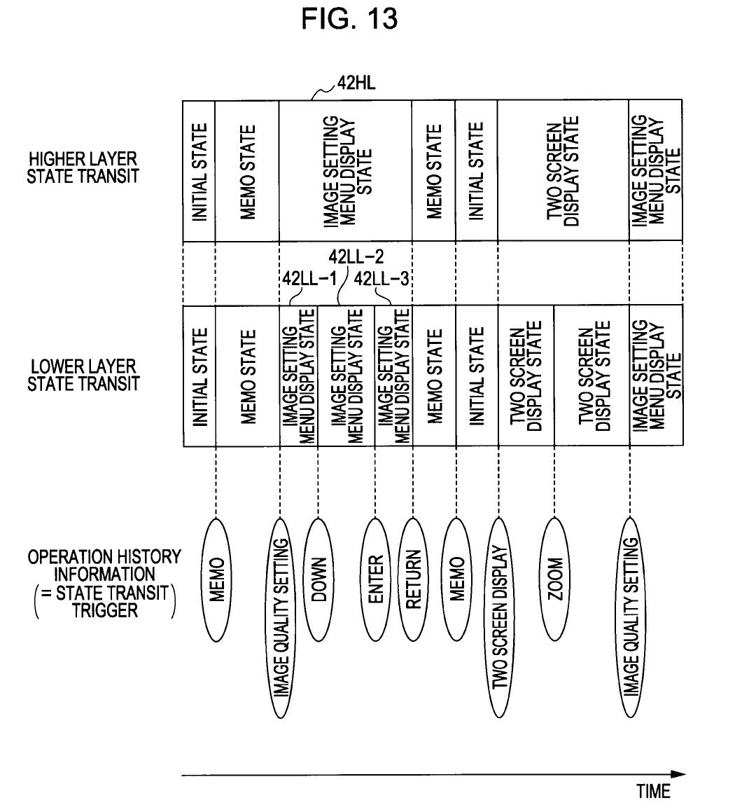

Herein, FIG. 13 shows a case in which the operation history codes are integrated.

From the pre-processed operation history information (remote control code), the state of the lower layer (lower hierarchy) and the higher layer (upper hierarchy) is derived. This integration of the operation history information is utilized for deciding a type of the operation pattern obtained in the analysis to be carried out on the operation pattern and limiting the bound position in the next bound position setting unit.

FIG. 13 shows the operation history information, the state transit of the lower layer, and the state transit of the higher layer which are state transit triggers.

The operation history information is raw log data, and the above-mentioned remote control code (SIRS code), the processing code in the device, and the like correspond to the operation history information.

The state transit of the lower layer is a state transit in a stage where the remote controller is operated. The operation contents allocated to the remote control codes are represented in an upper concept. Therefore, the processing is carried out as an another state even when the “appearance” on the user interface is not changed.

In addition, the state transit of the higher layer is a state transit in a stage of the function, which is matched with the “appearance” state viewed from the user. In other words, the respective states in the lower layer are wrapped up for each of the same categories. That is, this is the OSD menu hierarchy and is equivalent to various processing modes (such as two screen display).

The description is returned to the explanation on the flow chart of FIG. 12.

In step S21-2 (bound position setting unit), the pre-processed and integrated long-term operation history codes are wrapped up into a block of the operation histories having the same purpose (the series operation). For example, in the case of the television set, when “brightness setting” and “volume adjustment” are performed in this order, this is equivalent to a case in which a bound is set between the series operation related to “brightness setting” and the series operation related to “volume adjustment”, and the respective series operations are wrapped up as a block of the operation histories having the same purpose.

For the deciding method for the bound position, for example, the following rules are combined, but the position is not limited to these candidate positions.

(1) Position between adjacent operation history codes which are not integrated in the operation history integration processing. In the example of FIG. 13, the positions are indicated by undulating lines. For example, the position corresponds to the respective border parts between the respective operation history information, image quality setting menu display states 42LL-1, 42LL-2, and 42LL-3 of the lower layer, and an image quality setting menu display state 42HL of the higher layer. An assembly of the relevant candidate positions is set as SA.
(2) Position between adjacent operation history codes whose time interval is larger than a threshold δ. The threshold δ may be previously decided as a value common to all the operation history codes, or the value may be changed in accordance with the types of the operation history codes. In a case where the threshold is set as δ, an assembly of the relevant candidate positions is set as SB(δ).
(3) Position immediately before the operation history code which only appears at the beginning in the series operation decided by the rule (described in the operating manual of the operation device) or immediately after the operation history code which only appears at the last. An assembly of the relevant candidate positions is set as SC.
(4) Utilization of the internal state of the operation device. For example, in the case of the television set, positions of the power OFF and the power ON are actually investigated by utilizing the I2C code or the like, and a bound position is set at the relevant position or at a position before or after the relevant position. An assembly of the relevant candidate positions is set as SD.

For the combination methods, for example, when δb and δs are respectively a large threshold and a small threshold, various combinations of set intersection (∩) and union (∪) are selected such as (SA ∩ SB(δS)) ∪ SB (δb) so that the assembly of the bound positions can be decided.

After the processing in step S21, in step S22, the pre-processed operation history information is sectioned at the finally obtained bound positions, and the operation history codes are integrated when demanded. The finally obtained series operation pattern is accumulated to be supplied to the next pattern extraction unit 43.

In the example of FIG. 13, in the lower layer, the image quality setting menu display states 42LL-1, 42LL-2, and 42LL-3 exist with respect to the image quality setting button, the down button, and the enter button. Then, in the higher layer, the image quality setting menu display states 42LL-1, 42LL-2, and 42LL-3 of the lower layer are integrated into the single image quality setting menu display state 42HL.

### Operation of the Pattern Extraction Unit

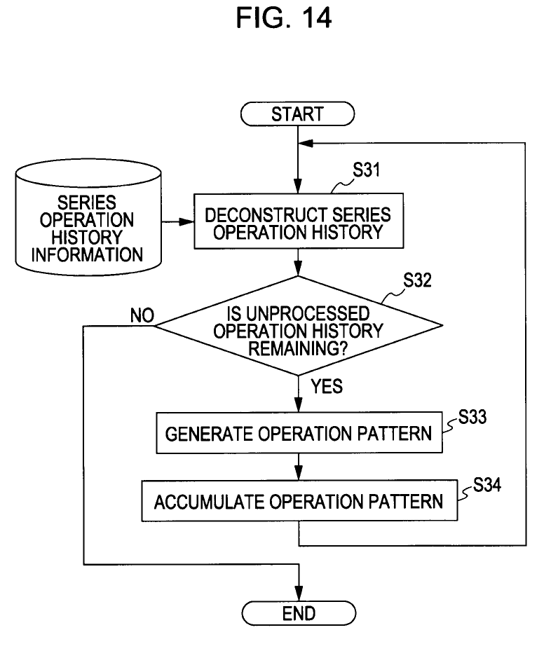

Next, with reference to a flow chart shown in FIG. 14, a processing example of the pattern extraction unit will be described.

In step S31 (series operation history deconstruction processing), when a pattern extraction processing is started, first, on the basis of the bound positions set by the series operation extraction unit 42, the respective series operation history codes is deconstructed to be sent to a determination processing in the next step S32 for each of the series operation history codes.

In step S32 (operation history remaining number determination processing), it is determined whether or not the unprocessed operation history information (the series operation history code) is remaining. When the unprocessed operation history information is remaining, the process advances to a determination processing in step S33, and when the unprocessed operation history information is not remaining, the pattern extraction processing is ended.

In step S33 (operation pattern generation processing), the operation pattern is extracted from the series operation history code. For the operation pattern, when demanded, for example, the following method is selected.

(1) From the respective series operations by M times (M is an integer), the extraction is performed from a starting position in a range in which the continuous operations by N times (M>N, N is fixed at an integer) can be taken. It is also conceivable that only the continuous operations by the first N times of the respective series operations or the continuous operations by the last N times are extracted, for example. In the following description, the case of two continuous operations times is exemplified, but is not limited to this example, and three continuous operations or the like may also be adopted.

### (2) The Respective Series Operations Themselves are Set as One Operation Pattern.

In step S34 (operation pattern accumulation processing) the operation patterns obtained in the operation pattern generation processing in step S33 are sequentially accumulated in a memory which is not shown in the drawing. The accumulated operation patterns are supplied to the next sequential rule extraction unit 44. After this processing is ended, the process advances to the processing in step S31, and the process is repeatedly performed until the processing for all the operation history codes is ended.

### Operation of the Sequential Rule Extraction Unit

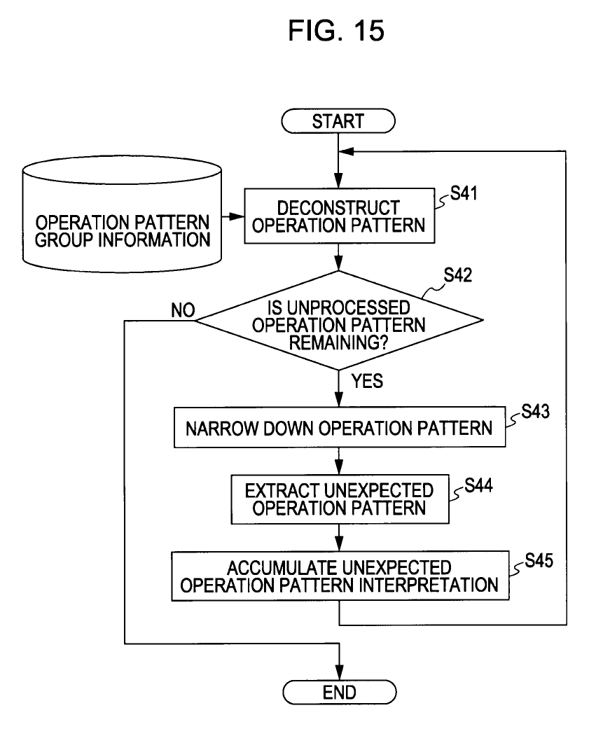

Next, with reference to a flow chart shown in FIG. 15, a processing example of the sequential rule extraction unit will be described.

In step S41 (operation pattern deconstruction processing), when the sequential rule extraction processing is started, first, the operation pattern group obtained in the pattern extraction unit 43 is deconstructed for each operation pattern and sequentially sent to an operation pattern remaining number determination processing in the next step S42 for each operation pattern.

In step S42 (operation pattern remaining number determination processing), it is determined whether or not the unprocessed operation pattern is remaining. When the unprocessed operation pattern is remaining, the process advances to an operation pattern narrowing down processing in step S43, and when the unprocessed operation pattern is not remaining, the sequential rule extraction processing is ended.

In step S43 (operation pattern narrowing down processing), the number of the obtained operation patterns falls within an allowable range to be dealt with by the pattern extraction unit 43, the operation patterns pass without narrowing down. However, the number of the operation patterns is extremely large and difficult to be dealt with by the pattern extraction unit 43, for example, the following rules are combined to be used as narrowing down conditions, and the operation patterns are narrowed down. It should be noted that for convenience of the description, the operation pattern is supposed “after a certain operation (group) A, or, due to a certain operation (group) A functioning as a cause, a certain operation (group) B appears”. After this processing is ended, the process advances to the processing in step S44.

Amount of Statistics: the Following Indices are Exemplified.
Frequency: a frequency of occurrence of the operation patterns. The operation patterns are narrowed down by setting an upper limit value and a lower limit value.
Certainty factor: a probability that an operation (group) B occurs on the promise that an operation (group) A occurs. This is comparable to a conditional probability “P(B/A)” and represents an association degree between the operation (group) A and the operation (group) B. The operation patterns are narrowed down by setting an upper limit value and a lower limit value.
Lift value: an influence degree in which the promise that the operation (group) A occurs contributes to the probability that the operation (group) B occurs. This is comparable to “P(B/A)/P(B)”, and when the calculation result exceeds 1, it is possible to determine that the pattern is a particularly meaningful operation pattern. The operation patterns are narrowed down by setting an upper limit value and a lower limit value.

Types of the Operation History Codes:

Narrowing down is performed to select only the operation patterns used by the history reflection section of the upgrade system (see FIG. 5), or a bias related to the frequency of occurrence of the operation patterns is corrected, so that narrowing down by way of the amount of statistics is set more effective.

Generation Time:

Narrowing down is performed by way of a period or the like in accordance with the number of days since the use start of the operation device. With this configuration, it is possible to analyze the aging change of the operation pattern.

In step S44 (an unexpected operation pattern extraction processing), from the operation patterns after the narrow down, with reference to the defined pattern DB 44A, the operation patterns which is high in possibility to be generated by the unexpected operation by the user are extracted as the new function (reflection information). For example, a case will be considered in which the operation of the remote controller on the television set is analyzed. Herein, only the operation patterns in which the certainty factor and the lift value are both high in the operation pattern narrowing down processing in step S43 are extracted.

Next, from the operation patterns, the unexpected operation pattern is extracted. The unexpected operation pattern can be classified as follows.

(1) An operation pattern realizing a new function in combination with the mounted function.
(2) Operation pattern attempting an operation which is not allowed to be executed as to the mounted function.

Herein, the mounted function is a function whose description is in the operating manual and which is executed by a defined operation procedure. This function can be previously defined (defined pattern). The defined pattern is previously registered in the defined pattern DB 44A.

The above-mentioned item (1) is an operation pattern indicating that the user discovers a use method valuable for itself by freely combining the provided functions. As to an operation pattern (A→B) of using another function (state B) in a certain function (state A), an expected event probability is roughly calculated through an experiment, and an operation pattern significantly deviating from the event probability, for example, an operation pattern exceeding a set threshold is extracted. This threshold is registered in the defined pattern DB 44A or the like together with the corresponding defined pattern. The event probability used for the standard may be obtained form data of other people (on the premise that logs are collected from a plurality of people) other than the previously roughly calculated value through the experiment.

The above-mentioned item (2) is an operation pattern indicating that as to the provided function, a function desired by the user is not provided. In a certain function (state A), an operation prohibited next can be previously classified, and the operation pattern is extracted.

Then, as to the respective extracted operation patterns, an investigation is performed on whether or not the operation pattern is an unexpected operation pattern, and a generation cause of the relevant operation pattern is derived.

The procedure of the above-mentioned sequential rule extraction will be described by way of specific examples.

The following example is limited to a case in which the last two continuous operations are extracted from the operation history information in step S33 (operation pattern generation) of the pattern extraction processing (see FIG. 14), and a case is supposed in which data on the unexpected operation pattern of the high certainty factor and the high lift value is obtained.

### (1) Pattern Realizing a New Function by Combining Mounted Functions

Operation Pattern 1:

For example, the interpretation is carried out in terms of the function, the operation pattern corresponds to a case in which this is thought to be generated while an image quality adjustment (for example, a DRC palette operation) is to be performed in a state where a capture function (memo) of the screen is utilized. The manufacturer side does not suppose such a use method or decreases the priority as many demands are not expected. However, such an operation pattern frequently appears in the respective users, information is obtained that the operation pattern unexpectedly has many demands. It should be noted that DRC (Digital Reality Creation) is a registered trademark of Sony Corporation.

Operation Pattern 2:

For example, the operation pattern is thought to be generated while the image quality adjustment (the DRC palette operation) is to be performed in the two screen display state (the image quality adjustment is not performed in the two screen state).

### (2) Pattern Attempting to Perform a Prohibited Operation in the Mounted Functions

Operation Pattern 3:

For example, the operation pattern corresponds to a case in which the size of the screen is to be changed in the memo state although the two screen display including the normal screen and the capture screen is established at present in the memo state (a case in which the size of the screen is not allowed to be changed in the definition).

In step S45 (the unexpected operation pattern interpretation accumulation processing), the interpretations of the respective unexpected operation patterns obtained in the unexpected operation pattern extraction processing are accumulated to be set as information utilized in the history reflection section of the upgrade system. For example, as the operation pattern interpreted that a large number of users attempt to perform the image quality adjustment in the memo mode, a finding is obtained that the demands for the image quality adjustment function are high in the memo mode.

From the above results, for example, the following reflection information (information used for the upgrade) is output.

### (1) Pattern Realizing a New Function by Combining Mounted Functions

The image quality adjustment function combined with the screen capture function
The image quality adjustment function combined with the two screen display function

### (2) Pattern Attempting to Perform a Prohibited Operation in the Mounted Functions

Two screen display size change function

Next, the reflection information generation unit 45 (see FIG. 5) will be described in detail.

The reflection information generation unit 45 mainly extracts the unexpected operation pattern in the higher layer of the operation history information and the prohibited operation pattern in the lower layer of the operation history information to generate the reflection information (new function) on the basis of the results. In the following description, as to the reflection information generation unit 45, the operation history information (see FIG. 13) will be explained separately in the case of the higher layer and the case of the lower layer.

### 3. History Analysis Section (Reflection Information Generation Unit According to an Embodiment of the Present Invention: in the Case of the Higher Layer)

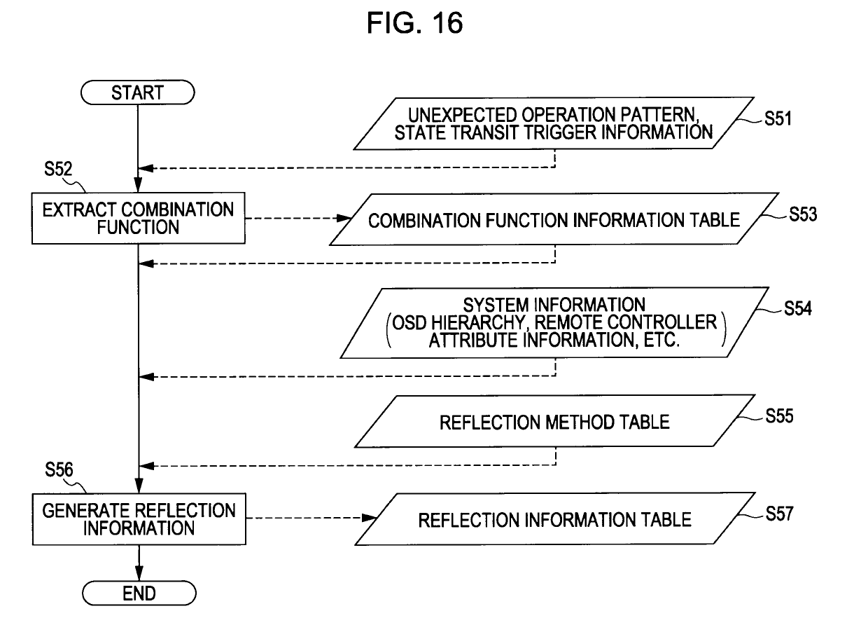

First, with reference to FIG. 16 to FIG. 20, an operation of the reflection information generation unit 45 in the case of the higher layer will be described.

FIG. 16 is a flow chart of a processing example on the higher layer of the operation history information by the reflection information generation unit 45 of the history analysis apparatus 40.

In step S51, when the reflection information generation processing is started, first, the reflection information generation unit 45 reads the unexpected operation pattern obtained in the unexpected operation pattern extraction processing by the sequential rule extraction unit 44 in the previous procedure (step S44) and the state transit trigger. After this processing is ended, the process advances to the processing in step S52.

In step S52, the reflection information generation unit 45 extracts the combination function constituting the unexpected operation. That is, the combination function (combination of operations) is extracted from the information on the unexpected operation pattern and the state transit trigger. After this processing is ended, the process advances to the processing in step S53.

In step S53, the reflection information generation unit 45 creates a combination function information table on the basis of the extracted combination function to be saved in the memory. After this processing is ended, in step S54, the process advances to the processing in step S55.

For example, in the example shown in FIG. 13, the state transit of the higher layer obtained from the operation history information follows “initial state”→“memo”→“image quality setting menu”→“memo”→“initial state”→“two screen display”→“image quality setting menu”. In this case, for the unexpected operation pattern, “(1) Pattern realizing a new function by combining mounted functions” is extracted. That is, a pattern of the state transit of the high frequency, the high certainty factor, and the high lift value “state A→state C” is the target. It should be noted that for the majority of other users, another state transit of the high frequency, the high certainty factor, and the high lift value, for example, “state A→state B” exists.

The specific extraction procedure for the unexpected operation pattern includes, as mentioned in the explanation of the sequential rule extraction unit 44, first extracting a desired state transit pattern for all the operation history information, and thereafter screening all the extracted patterns by way of statistical criteria (the frequency, the certainty factor, and the lift value). With this configuration, the accidentally generated unexpected operation pattern is removed, and only the meaningful unexpected operation pattern remains.

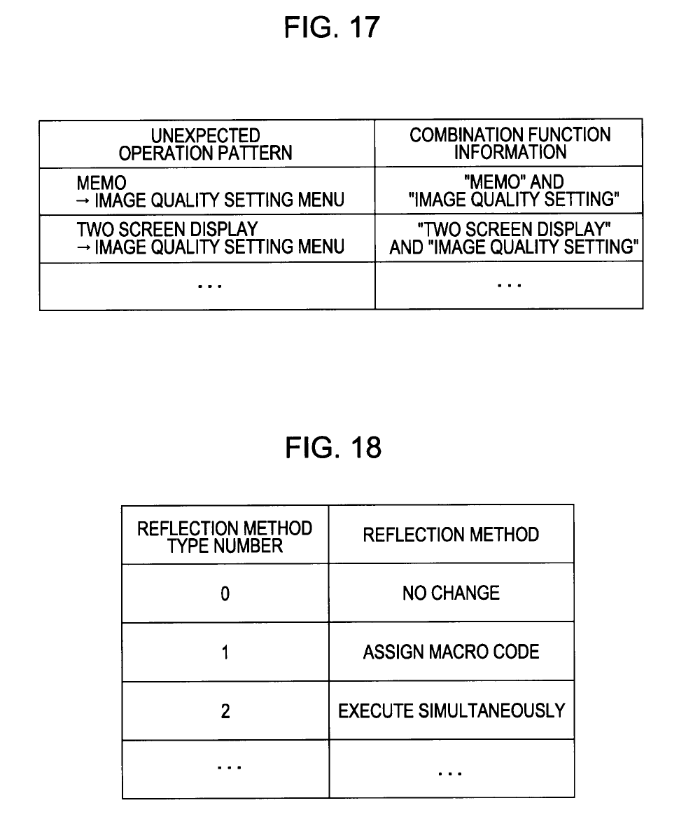

FIG. 17 shows an example of the combination function information table (higher layer).

The combination function information table includes “unexpected operation pattern” and “combination function information” for the fields. In the example shown in FIG. 17, for the unexpected operation pattern, “memo [symbol] the image quality setting menu” and “two screen display [symbol] the image quality setting menu” are extracted, and the respective pieces of the combination function information are “memo and image quality setting” and “two screen display and the image quality setting”.

Next, in steps S54 and S55, the reflection information generation unit 45 reads the system information and the reflection method table stored in the memory which is not shown in the drawing. The system information includes the OSD hierarchy (see FIG. 3), the attribute information of the remote controller 10 (see FIG. 2), and the like. The attribute information is information indicating which function is allocated to which button. After this processing is ended, the process advances to the processing in step S56.

FIG. 18 shows an example of the reflection method table (higher layer).

The reflection method table shown in FIG. 18 includes “reflection method type number” and “reflection method” for the fields. The reflection method is for defining which method (mode) of realizing the device upgrade. According to the present embodiment, when the reflection method type number is “0”, the reflection method is “no change”. Then, when the reflection method type number is “1”, the reflection method is to “allocate macro codes” to the buttons of the function 1 to 3. Also, when the reflection method type number is “2”, a record is registered that “simultaneously execute” the respective functions. It should be noted that the system information and the reflection method table described above are desirably prepared or defined previously before the analysis.

In step S56, on the basis of the combination function information table, the system information, the reflection method table saved in the memory, the reflection information utilized at the time of the upgrade is generated. After this processing is ended, the process advances to the processing in step S57.

In step S57, the reflection information generation unit 45 generates a reflection information table on the basis of the generated reflection information to be saved in the memory. After this processing is ended, the reflection information generation processing is ended.

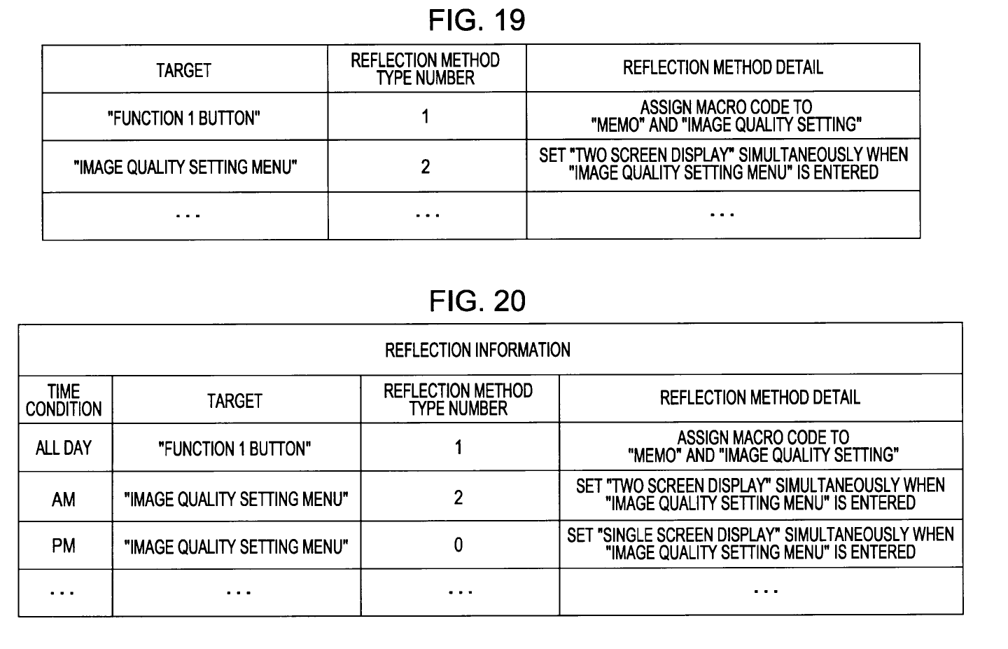

FIG. 19 shows an example of a reflection information table (higher layer).

The reflection information includes information used for the upgrade of the target device. The reflection information table shown in FIG. 19 includes “(reflection) target”, “reflection method type number” and “reflection method detail” for reflecting the function on the reflection target for the fields. As to the example according to the present embodiment, for an example of the upgrade of the remote controller, it is described that the target is “function 1 button”, the reflection method type number is “1”, and the reflection method detail is (assign macro code of “memo”+“image quality setting”). Also, for an example of the upgrade of the OSD, it is described that the target is “image quality setting menu”, the reflection method type number is “2”, and the reflection method detail is (“two screen display” is performed simultaneously when “image quality setting menu” is entered).

The reflection information (upgrade information) described in the above-mentioned reflection information table is reflected on the signal processing apparatus of the history reflection apparatus 50. Alternatively, the reflection information is distributed to the history reflection apparatus 50 through the network, and the upgrade target function among the interface functions sorted in the storage unit inside the history reflection apparatus 50 is updated.

### Modified Example of the Reflection Information Table (Higher Layer)

FIG. 20 shows an example of the reflection information table (higher layer) in a case where a time-varying element (time condition) is input to the reflection information table shown in FIG. 19.

In the example shown in FIG. 20, “all day” is added as the time condition to the record where the target is “function 1 button”. This means that the basis is on the unexpected operation pattern extracted from all the all-day operation histories. Also, “AM” and “PM” are added as the time conditions to the two records where the target is “image quality setting menu”. The respective records mean that the basis is on the unexpected operation pattern extracted only from the operation history information in AM and PM, respectively.

It is expected that the users may have different operation patterns because the life style rhythms, feelings, and the like are different in week days and week ends, morning, day time, and night, for example. In view of the above, by taking these time conditions into the reflection information, the unexpected operation patterns are extracted more appropriately and flexibly in accordance with the life style rhythms, and the like of the users to realizing the finding and introduction of the new functions. For example, in the example of FIG. 20, in the case of AM, at the time of the “image quality setting menu” state, “two screen display” is set, and the image quality comparison mode is established in which the presentation information amount is increased. On the other hand, in the case of PM, at the time of the “image quality setting menu” state, “single screen display” is set, and a careful image quality adjustment function mode designed for movies and drama programs is established.

### 4. History Analysis Section According to an Embodiment of the Present Invention (a Reflection Information Generation Unit: in the Case of the Lower Layer)

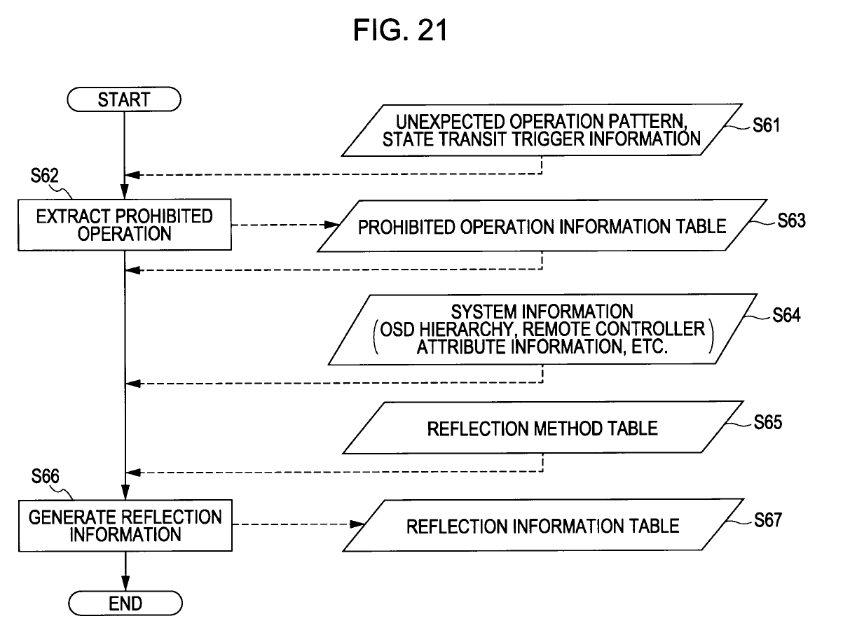

First, while referring to FIGS. 21 to 24, an operation of the reflection information generation unit 45 will be described in the case of the lower layer.

FIG. 21 is a flow chart of a processing example on the lower layer of the operation history information by the reflection information generation unit 45 of the history analysis apparatus 40.

In step S61, when the reflection information generation processing is started, first, the reflection information generation unit 45 reads the unexpected operation pattern obtained in the unexpected operation pattern extraction processing by the sequential rule extraction unit 44 in the previous procedure (step S44) and the state transit trigger. After this processing is ended, the process advances to the processing in step S62.

In step S62, the reflection information generation unit 45 extracts the unexpected prohibited operation. After this processing is ended, the process advances to the processing in step S63.

In step S63, the reflection information generation unit 45 creates a prohibited operation information table on the basis of the extracted prohibited operation to be saved in the memory. After this processing is ended, the process advances to the processing in steps S64 and S65.

For example, in the example shown in FIG. 13, the state transit of the lower layer obtained from the operation history information follows the initial state→the memo→the image quality setting menu→the image quality setting menu→the image quality setting menu→the memo→the initial state→two screen display→two screen display→the image quality setting menu. At this case, for the unexpected operation pattern, “(2) Pattern attempting to perform a prohibited operation in the mounted functions” is extracted. That is, a pattern out of the use method supposed by the manufacturer side (defined operation) is targeted.

The specific extraction procedure of the unexpected operation pattern includes, similarly as in the case of the higher layer, as mentioned in the explanation of the sequential rule extraction unit 44, first extracting the desired state transit pattern with respect to all the operation history information, and thereafter screening all the extracted patterns by way of statistical criteria (the frequency, the certainty factor, and the lift value). With this configuration, the accidentally generated unexpected operation pattern is removed, and only the meaningful unexpected operation pattern remains.

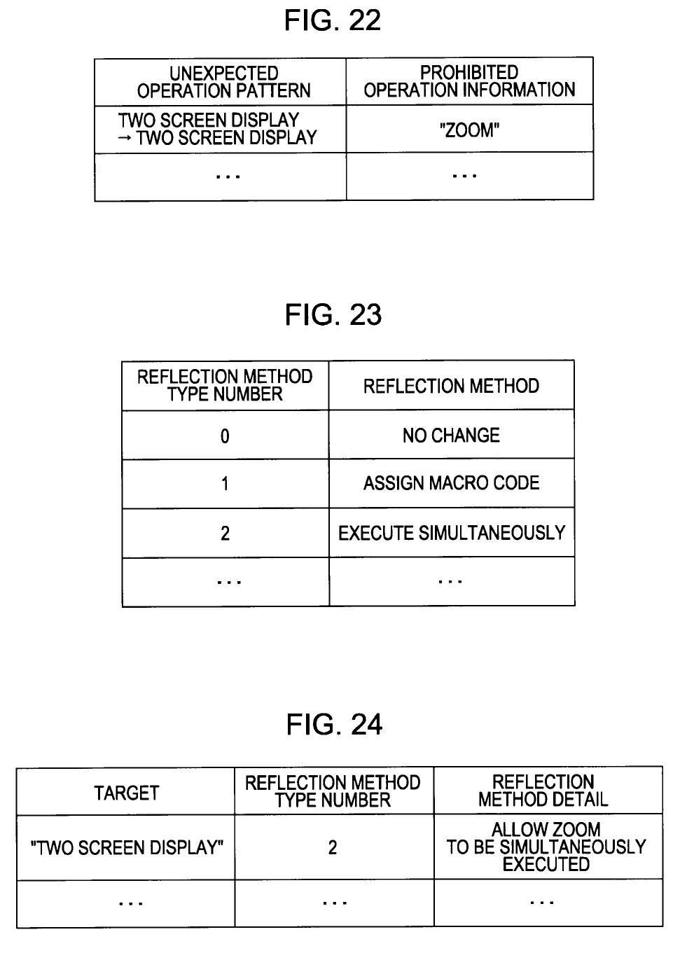

FIG. 22 shows an example of the prohibited operation information table (lower layer).

The prohibited operation information table includes “unexpected operation pattern” and “prohibited operation information” for the fields. In the example shown in FIG. 22, for the unexpected operation pattern, “two screen display [symbol] two screen display” is extracted, and the corresponding prohibited operation information is “zoom”.

Next, in steps S64 and S65, the reflection information generation unit 45 reads the system information and the reflection method table stored in the memory which is not shown in the drawing. The system information includes the OSD hierarchy (see FIG. 3), the attribute information of the remote controller 10 (see FIG. 2), and the like. After this processing is ended, the process advances to the processing in step S66.

FIG. 23 shows an example of the reflection method table (lower layer).

The reflection method table shown in FIG. 23 is the same as the reflection method table in the case of the higher layer shown in FIG. 18, and a detailed description will be omitted. It should be noted that the system information and the reflection method table described above are desirably prepared or defined previously before the analysis.

In step S66, on the basis of the combination function information table, the system information, the reflection method table saved in the memory, the reflection information utilized at the time of the upgrade is generated. After this processing is ended, the process advances to the processing in step S67.

In step S67, the reflection information generation unit 45 creates the reflection information table on the basis of the generated reflection information to be saved in the memory. After this processing is ended, the reflection information generation processing is ended.

FIG. 24 shows an example of the reflection information table (lower layer).

The reflection information includes information used for the upgrade of the target device. The reflection information table shown in FIG. 24 includes “target”, “reflection method type number”, and “the reflection method detail” for the fields. As to the example according to the present embodiment, for an example of the upgrade of the OSD menu, it is described that the target is “the two screen display function”, the reflection method type number is “2”, and the reflection method detail is “allow zoom to be simultaneously executed (with two screen display function)”.

### 5. History Reflection Section According to an Embodiment of the Present Invention

Next, the history reflection section (see FIG. 5) according to an embodiment of the present invention will be described.

In the history reflection section, a meaningful new function whose new demands are found from the user side is provided by using the sequential rule extracted by the sequential rule extraction unit 44 (upgrade). For the realization method, the signal processing apparatuses in the history reflection apparatuses 50-1 to 50-n existing on the user side are collected on the center side. After all the components or only a substrate apparatus such as an integrated circuit related to the signal processing is replaced, the signal processing apparatuses are returned to the user side. Alternatively, such a procedure may be adopted that the new signal processing apparatus is sent to the user side to be connected to the signal processing apparatus existing on the user side for providing the new function and the like. Furthermore, also, the memory (storage apparatus) storing the upgraded program or data for governing the user interface may be replaced, or the upgrade information may also be added to the memory.

Hereinafter, a case will be described in which the history reflection apparatus 50 to which the new function is provided is applied to a television receiver.

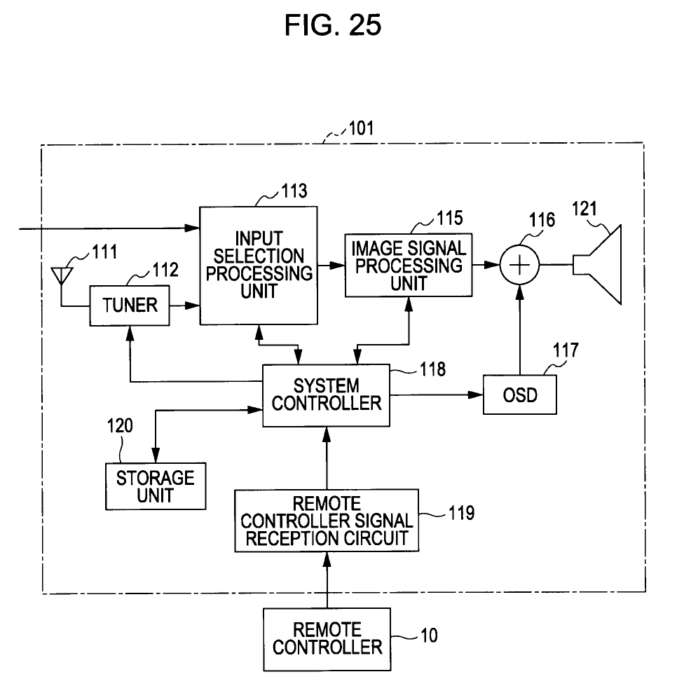

FIG. 25 is a block diagram of an internal configuration example of the television receiver to which the new function is provided.

A tuner 112 of television receiver 101 performs a channel selection processing, an intermediate frequency amplification processing, a detection processing, and the like on broadcasting signals (RF modulation signals) captured by a reception antenna 111 to extract SD (Standard Definition) signals to be supplied to an input selection processing unit 113.

To the input selection processing unit 113, in addition to the SD signals from the tuner 112, image signals or digital video signals from a DVD (Digital Video Disc), a video tape recorder, and the like (all of which are not shown in the drawing) are input.

The input selection processing unit 113 selects a predetermined signal while following a control of a system controller 118 and also performs a pre-processing in accordance with the selected signal. Then, the input selection processing unit 113 supplies the resultant image signal to an image signal processing unit 115.

The image signal processing unit 115 has a function of generating HD (High Definition) signals (1050i signals or 525p signals) from the SD signals (525i signals), a function of adjusting a resolution and a noise volume, a zoom function with which a part of the displayed image can be expanded, and the like, and the image processing is carried out in accordance with the functions and conditions set by the user.

An OSD (On Screen Display) circuit 117 generates display signals for displaying a character, a figure, and the like on a screen of a display unit 121 to be supplied to a synthesizer 116. That is, the synthesizer 116 synthesizes the display signals supplied from the OSD circuit 117 with the HD signals from the image signal processing unit 115 to be supplied to the display unit 121.

The system controller 118 follows signals supplied from a remote controller signal reception circuit 119 and signals indicating the user operation input supplied from an operation input unit (not shown) when demanded to control the respective units.

For example, the system controller 118 sends the selection signal to the tuner 112 and the input selection processing unit 113 and control the operation of the OSD circuit 117. The system controller 118 stores information indicating the viewed image such as the information indicating the channel selected by the tuner 112 (which can include the image broadcasting time, the program name, and the like) (hereinafter which will be referred to as selection information) and the control information supplied from the remote controller signal reception circuit 119 (contents input by the user while operating the remote controller, and the like) in a storage unit 120.

Also, the storage unit 120 stores a program for operating the system controller 118 and upgrade information of the program. It should be noted that the storage contents of the storage unit 120 can be transferred to the manufacturer via the network, the manufacturer and the like can send the upgrade information for adding the new function to the remote controller 10, the OSD circuit 117, and the like from the outside to be stored on the storage unit 120.

In the case of the television receiver 101 according to the present embodiment, the system controller 118 is comparable to the signal processing unit 31 of the history collection apparatus 30 (see FIG. 5), and the OSD circuit 117 is comparable to the user interface 32. In order to upgrade the function, the system controller 118 or the OSD circuit 117 may be replaced. Alternatively, in a case where the user interface function of the television receiver 101 is based on the program or data stored in the storage unit 120, rewrite or addition may be performed on the program or data stored in the storage unit 120, for example to write the update information to the upgrade information.

### 6. Upgrade (Common, the Higher Layer, the Lower Layer) Upgrade: Common

Hereinafter, a specific example of upgrade by the history reflection section will be described.

The following two cases are roughly conceivable as to the reflection destination of the new function (upgrade information) The first case is that the new function found by a certain group is to be reflected on a group of itself. In this case, the new function is provided in a mode where the ease of use is improved (providing macro commands, etc). The second case is that the new function found by a certain group is to be reflected on another group. That is, the new function is provided in a mode where the function which is not found by itself is recommended by other people.

Examples of the reflection method for the new function are as follows.

### (1) Pattern Realizing a New Function by Combining Mounted Functions

1-1: A command macro in which a plurality of the plurality of functions are combined is prepared to be assigned to the remote controller button.

1-2: An item in which the plurality of functions are combined is newly added to the OSD menu.

### (2) Pattern Attempting a Prohibited Operation in the Mounted Function

The prohibited operation in the mounted function is cancelled (the function intended by the user is prepared).

As a specific example of the above-mentioned 1-1, for example, the command macro for opening the image quality adjustment menu at the same time as the screen capture (memo) is allocated to the remote controller (“function button 1” of FIG. 19). Also, as a specific example of the above-mentioned 1-2, for example, the command macro (OSD menu) for opening the image quality adjustment menu at the same time as two screen display is also conceivable (“image quality adjustment menu” of FIG. 19). Furthermore, as a specific example of the above-mentioned (2), for example, a function of adjusting the size of the screen or the like is prepared at the same time as two screen display.

With the above-mentioned configuration, the product develop reflecting the user's demands which is difficult for the manufacturer side alone to determine can be carried out.

In the following description, specific examples of the upgrade by the history reflection section will be described separately in the case of the higher layer and the case of the lower layer.

### Specific Example in the Case of the Higher Layer

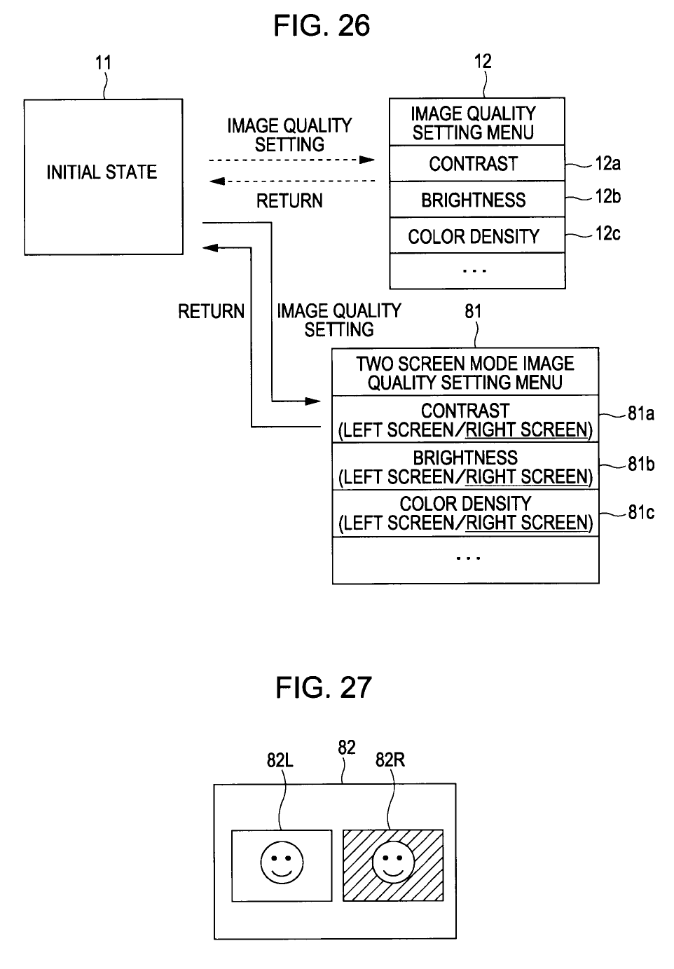

FIG. 26 shows an upgrade example of the OSD menu (higher layer). The example shown in FIG. 26 corresponds to a case in which the OSD menu (hierarchy display) shown in FIG. 3 is upgraded to add the image quality setting menu at the time of the two screen mode. FIG. 27 shows the image quality setting example at the time of the two screen mode.

In FIG. 26, when the image quality setting button of the remote controller 10 is pressed at the time of the initial state 11, in addition to the image quality setting menu 12, a two screen mode image quality setting menu 81 is displayed. Which menu is displayed or which menu is entered may be set by the user. According to the present embodiment, the two screen mode image quality setting menu 81 is provided with contrast (left screen/right screen) 81a, brightness (left screen/right screen) 81b, color density (left screen/right screen) 81c for pull down menus. By providing the two screen mode image quality setting menu 81 as the new function, it is possible to obtain an interface with which the image quality of one screen 82R (or 82L) in the two screen mode (display screen 82) shown in FIG. 27 can be set. Alternatively, the image qualities of both the screens 82R and 82L can be set.

### Specific Example in the Case of the Lower Layer

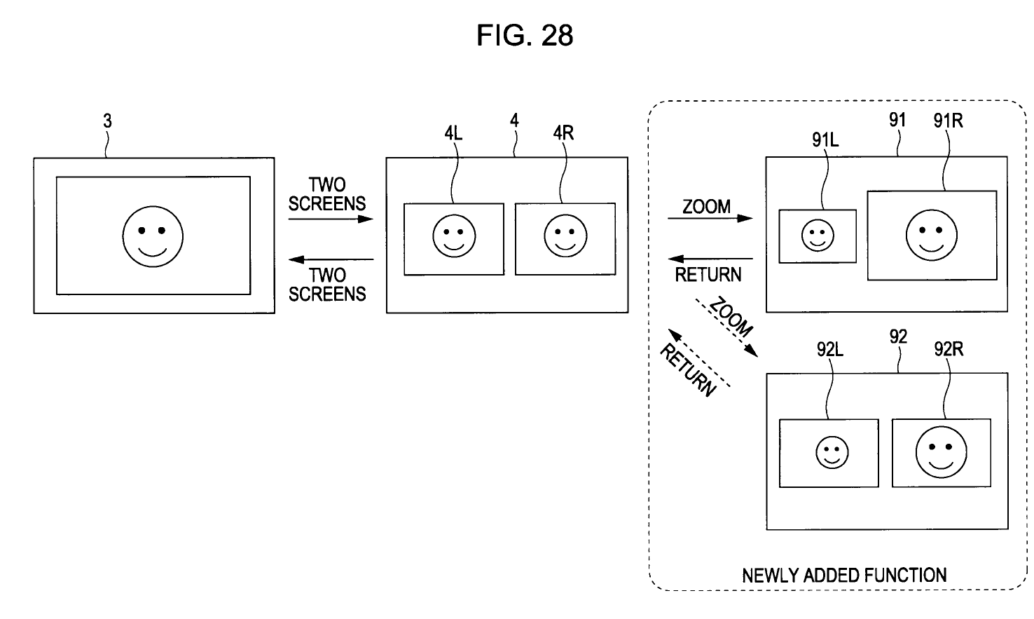

FIG. 28 shows an upgrade example of the two screen mode (lower layer).

The example shown in FIG. 28 is an example in which unlike the zoom function not used at the time of the two screen mode in the related art, the zoom function can be used at the time of the two screen mode through the upgrade by utilizing the embodiment of the present invention. While the zoom button is operated with respect to the display screen 4 (two screen mode) for displaying the two screens, the display sizes of screens 91R and 91L specified in a display screens 91 can be increased or decreased. Also, while the zoom button is operated at the time of the two screen mode, the size of the image displayed on screens 92R and 92L specified in a display screens 92 can be increased or decreased.

### 7. Upgrade in Units of Group

The upgrade described above can be performed for each user, but while organizing a plurality of users having the same characteristic into a group, if the upgrade is performed for each group, more advantages can be attained in terms of manufacturing costs.

For example, it is conceivable that sequential rules related to the unexpected operations are extracted from the respective users, and only the sequential rules obtained from at least a certain number of users are set as upgrade targets. In addition, as to on which sequential rules the upgrade is performed for the respect users, for example, the following methods can be exemplified.

(1) All sequential rules set as upgrade targets

(2) Sequential rules relevant to the respective users among sequential rules set as upgrade targets

(3) Sequential rules not relevant to the respective users among sequential rules set as upgrade targets

Also, the following methods are exemplified for setting the users as the investigation objects at a time.

(1) All the users whose operation history is collected

(2) User group to which at least a certain number of sequential rules are relevant (for example, several standard sequential rule strings are prepared from the viewpoints of cost rules upon mounting and realization possibilities, and users to which at least a certain number of the respective elements of the respective sequential rule strings are relevant are extracted.)

### First Specific Example: Upgrade in Units of Group

Next, a first specific example of the upgrade in units of group will be described.

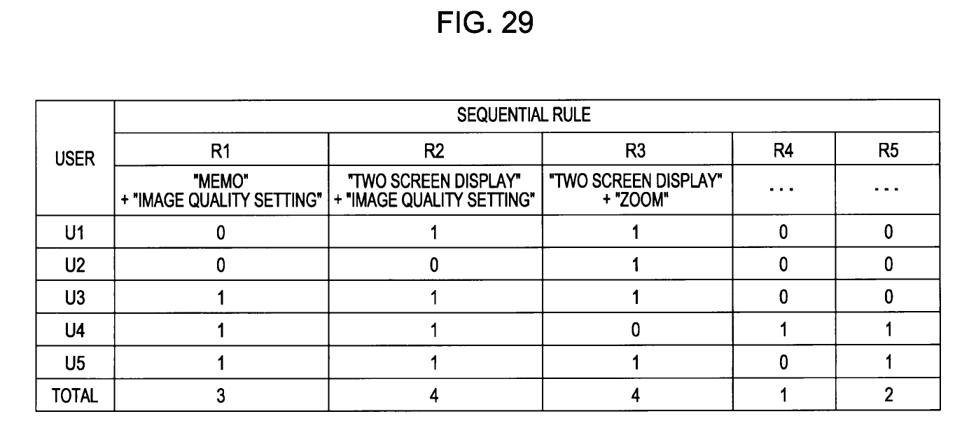

FIG. 29 is an explanatory diagram for describing the upgrade in units of group. In a table shown in FIG. 29, records U1 to U5 exist for the fields of sequential rule R1 to R5. The rule R1 is “memo” and “image quality setting”. The rule R2 is “two screen display” and “image quality setting”. The rule R3 is “two screen display” and “zoom”. The rules R4 and R5 are omitted. In this table, when the user operation is relevant to the sequential rule, “1” is set, and when the user operation is not relevant to the sequential rule, “0” is set.

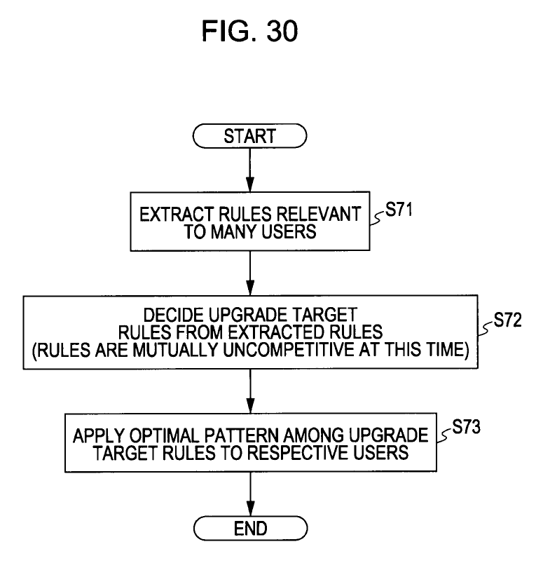

FIG. 30 is a flow chart of an upgrade processing example in units of group. With reference to FIGS. 29 and 30, the upgrade processing example in units of group will be described.

First, in step S71, a rule relevant to a large number of users is extracted. For example, in a case where a “rule relevant to at least 50% of users (=2.5 users or above)” is extracted, the rules R1, R2, and R3 are relevant. After this processing is ended, the process advances to step S72.

In step S72, from the extracted sequential rules, the upgrade target rules are decided. At this time, rules are set not to compete against each other. After this processing is ended, the process advances to the processing in step S73.

For example, in a case where the rule R1 and the rule R2 compete against each other (both the rules are not applied at the same time), combinations of the upgrade target rules can be represented as follows.

A1=(1, 0, 0, 0, 0)→only the rule R1 can be applied
A2=(0, 1, 0, 0, 0)→only the rule R2 can be applied
A3=(0, 0, 1, 0, 0)→only the rule R3 can be applied
A4=(1, 0, 1, 0, 0)→the rules R1 and R3 can be applied
A5=(0, 1, 1, 0, 0)→the rules R2 and R3 can be applied

In step S73, for the respective users (target devices, an optical pattern is applied among the upgrade target rules to perform the upgrade. After this processing is ended, the upgrade processing example in units of group is ended.

According to the first specific example, when an optimal pattern is applied among the upgrade target rules, for each relevant rule B to the respective users, the upgrade target rules Ax (in this example, x=1 to 5) satisfying the following condition are derived.

“rule Ax in which |Ax&( [symbol] B)|=0 established and also |Ax&(B)| becomes the largest”

This condition represents that under a constraint that the user upgrades the sequential rule relevant to itself, as many sequential rules as possible are upgraded. It should be noted that |Ax| indicates the number of relevant rules of Ax (which is comparable to a single number). In addition, “ [symbol] B” indicates negation of B.

For example, for the user U1, at the time of B=(0, 1, 1, 0, 0), when the above-mentioned condition is calculated, the results are as follows.

|A1&( [symbol] B)|=|(1,0,0,0,0)|=1

|A2&( [symbol] B)|=|(0,0,0,0,0)|=0

|A3&( [symbol] B)|=|(0,0,0,0,0)|=0

|A4&( [symbol] B)|=|(1,0,0,0,0)|=1

|A5&( [symbol] B)|=|(0,0,0,0,0)|=0

|A2&B|=|(0,1,0,0,0)|=1

|A3&B|=|(0,0,1,0,0)|=1

|A5&B|=|(0,1,1,0,0)|=2

From the above-mentioned result, the sequential rule A5 is applied to the user U1. That is, the upgrade of the rules R2 and R3 is executed for the target device. In this manner, under a constraint that the user upgrades the sequential rule relevant to itself, as many sequential rules as possible can be upgraded.

### Second Specific Example: Upgrade in Units of Group

Next, a second specific example of the upgrade in units of group will be described.

According to the second specific example, a table used in the first specific example (FIG. 29) is used. Also, the upgrade processing in units of group according to the second specific example is different in a condition applied in the processing in step S3 of the flow chart which is referred to according to the first specific example.

According to the second specific example, similarly as in the first specific example, the processing in steps S71 and S72 is executed. This processing is the same as that in the first specific example, and a description thereof is omitted. After these processings are ended, the process advances to the processing in step S73.

In step S73, for the respective users (target devices, an optical pattern is applied among the upgrade target rules to perform the upgrade. After this processing is ended, the upgrade processing example in units of group is ended.

According to the second specific example, when an optimal pattern is applied among the upgrade target rules, for each relevant rule B to the respective users, the upgrade target rules Ax satisfying the following condition (in this example, x=1 to 5) are derived.

“Rule Ax in which |Ax (XOR)B| becomes the smallest”

This condition represents that rules which are not relevant to itself is also included, and a pattern closest to its own pattern is derived. It should be noted that “XOR” indicates EXCLUSIVE-OR, and |A (XOR)B| indicates a Hamming distance between A and B.

For example, for the user U1, at the time of B=(0, 1, 1, 0, 0), when the above-mentioned condition is calculated, the results are as follows.

|A1(XOR)B|=|(1,1,1,0,0)|=3

|A2(XOR)B|=|(0,0,1,0,0)|=1

A3(XOR)B|=|(0,1,0,0,0)|=1

A4(XOR)B|=|(1,1,0,0,0)|=2

A5(XOR)B|=|(0,0,0,0,0)|=0

From the above-mentioned results, the sequential rule A5 is applied to the user U1. That is, the upgrade of the rules R2 and R3 is executed for the target device. In this manner, while the sequential rules which are not relevant to the user itself are also included and a pattern closest to its own pattern is derived, the upgrade can be carried out.

For example, the history analysis apparatus 40 stores the table for the upgrade in units of group shown in FIG. 29 together with the reflection information table (see FIGS. 19 and 24) in the reflection information accumulation apparatus 40M or the like. Then, the new function which should be upgraded on the basis of the table is distributed via the network to the history reflection apparatus 50 possessed by the relevant user, and the program or the data governing the user interface of the storage unit 120 is upgraded. Alternatively, the signal processing apparatus such as the system controller 118 or the OSD circuit 117 may also be replaced by an apparatus having a specification to which the upgrade information is reflected.

According to the embodiment described above, from the records of the operation history of the user, the state of the device, and the like, by finding the unexpected sequential rule, the introduction of the new function which is not expected on the manufacturer side can be realized.

For example, as the histories are collected from a large number of users, any of operation patterns can be exhaustively collected. Thus, the valuable new function can be found out even when the function appears at a low frequency. Also, the unexpected operation performed by one user (group) leads to the new function development and distributed to other users (groups). Furthermore, as compared with a method of executing a questionnaire, it is also possible to obtain the information from the unconscious operations of the user. Thus, the potentially existing unexpected operation can be collected, and which as a result leads to the discovery of the unexpected new function.

### 8. Others

It should be noted that the embodiment of the present invention can be applied, in addition to the above-mentioned television receiver, to electronic devices (for example, a game device, a personal computer, a mobile terminal, a mobile telephone, an electronic dictionary, a digital still camera, a digital video camera, and the like) for collecting the different pieces of operation history information depending on use environments when the user operations are input and the internal states of the devices are characteristically changed, for example.

Also, according to the present embodiment, the configuration is adopted that the history analysis apparatus 40 obtains the operation history information from the operation history information accumulation apparatus 30M, but the operation history information accumulation apparatus 30M itself may also include the function of the history analysis apparatus 40. That is, a configuration may also be adopted that the above-mentioned electronic device of the television receiver or the like also includes the function of the history analysis apparatus 40, and in accordance with the operation history information obtained on the basis of the operations on the television receiver, the above-mentioned television receiver itself generates the reflection information.

Also, the above-mentioned series of processings performed by the history analysis apparatus 40 can be executed by using hardware and also can be executed by using software. The function of executing these processings can of course be realized by using a combination of hardware and software. In a case where the series of processings is executed by using the software, a computer in which a program constructing the software is incorporated in a dedicated-use hardware is used, or a program is installed from a program recording medium to a general-use computer capable of executing various functions by installing various programs, for example.

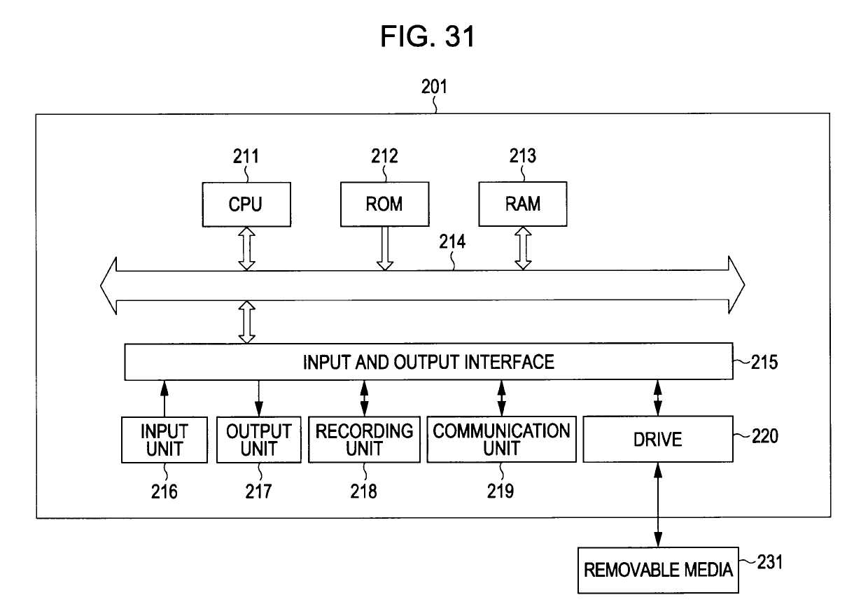

FIG. 31 is a block diagram of a configuration example of a computer for executing the above-mentioned series of processings by way of the program. A computer 201 may be composed, for example, of a personal computer provided with a certain performance, other than a dedicated-use computer having a higher performance for executing the above-mentioned series of processings.

A CPU (Central Processing Unit) 211 of the computer 201 follows a program recorded on a ROM (Read Only Memory) 212 or a recording unit 218 to execute various processings in addition to the above-mentioned series of processings. A RAM (Random Access Memory) 213 appropriately stores the program executed by the CPU 211 and also stores data, etc. The CPU 211, the ROM 212, and the RAM 213 are mutually connected via a bus 214.

An input and output interface 215 is connected to the CPU 211 via the bus 214. An input unit 216 composed of a key board, a mouse, a microphone, and the like and an output unit 217 composed of a display, a speaker, and the like are connected to the input and output interface 215. The CPU 211 executes various processings in response to instructions input from the input unit 216. Then, the CPU 211 outputs processing results to the output unit 217.

The recording unit 218 connected to the input and output interface 215 is composed of, for example, a hard disc drive and records the program executed by the CPU 211 and various pieces of data.

A communication unit 219 communicates with an external apparatus via a network such as the internet or a local area network. Also, the program may be obtained via the communication unit 219 to be recorded in the recording unit 218.

When a removable media 231 such as a magnetic disc, an optical disc, an opto-magnetic disc, or a semiconductor memory is mounted to a drive 220 which is connected to the input and output interface 215, the drive 220 drives the removable media 231 and obtains a program, data, or the like recorded thereon. The obtained program or data is transferred to the recording unit 218 and recorded when demanded.

The program recording medium which is installed to the computer and stores the program in an executable state by the computer is provided as a package media by way of the removable media 231 as shown in FIG. 17. For the removable media 231, a magnetic disc (including a flexible disc), an optical disc (including a CD-ROM (Compact Disc-Read Only Memory), a DVD (Digital Versatile Disc), and an opto-magnetic disc), a semiconductor memory, or the like can be applied. Alternatively, the program recording medium is composed of the ROM 212 temporarily or enduringly storing (recording) the program, a hard disc drive constituting the recording unit 218, or the like.

The storage of the program into this program recording medium is carried out by utilizing a wired or wireless communication medium such as a local area network (LAN), the internet, or the digital satellite broadcasting, when demanded, via the communication unit 219 which is an interface such as a router or a modem.

It should be noted that in the present specification, the processing steps describing the program stored in the program recording medium of course include a processing performed in a time series manner in the stated order and also include a processing in which the steps are executed in a parallel manner or individually without being performed in the time series manner (for example, a parallel processing or a processing by way of objects).

Also, the program may be processed by a single computer or dispersedly processed by a plurality of computers.

Furthermore, the program may also be transferred to a remote computer and executed.

The present application contains subject matter related to that disclosed in Japanese Priority Patent Application JP 2008-159727 filed in the Japan Patent Office on Jun. 18, 2008, the entire content of which is hereby incorporated by reference.

The embodiments described above are specific preferred example for executing the present invention, and therefore technically preferable various limitations are added thereto. It should be noted the present invention is not limited to these embodiments unless a particular limitation to the present invention is stated in the explanation of the above-mentioned embodiments. Therefore, for example, the processing time, the processing order, and the numeric conditions of the respective parameters in the above explanation are merely preferably examples, and also, the dimensions, the shapes, the arrangement relations, and the like are also schematic representations for illustrating the exemplary embodiments. Therefore, the embodiments of the present invention is not limited to the above-mentioned exemplary embodiments and it should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a pattern extraction unit configured to extract operation patterns from operation history information at least including an operation history of a user and information on a device state obtained from a plurality of operation target devices;
a defined pattern database configured to previously register a defined pattern which is a pattern of a combination of defined operations in accordance with the operation target devices;
a rule extraction unit configured to extract an unexpected operation pattern from the operation patterns extracted by the pattern extraction unit with reference to the defined pattern database; and
a reflection information generation unit configured to generate reflection information to be reflected on a function of the operation target devices from the unexpected operation pattern.

2. The information processing apparatus according to claim 1,
wherein the operation pattern is a combination of continuous operations performed by a predetermined number of times.

3. The information processing apparatus according to claim 2,
wherein the unexpected operation pattern is an operation pattern composed of a combination of defined operations, and a threshold set while corresponding to the defined operation is registered in the defined pattern database, and
wherein the rule extraction unit extracts, in a case where an event probability of the operation pattern extracted by the pattern extraction unit exceeds the threshold set while corresponding to the defined operation, the operation pattern as the unexpected operation pattern.

4. The information processing apparatus according to claim 3,
wherein the reflection information includes information related to a reflection target and a reflection method of reflecting the reflection information on the reflection target.

5. The information processing apparatus according to claim 4,
wherein the reflection information generation unit generates reflection information for reflecting the reflection information based on the unexpected operation pattern which is extracted from the operation history information obtained from an arbitrary operation target device on the operation target device.

6. The information processing apparatus according to claim 4,
wherein the reflection information generation unit generates reflection information for reflecting the reflection information based on the unexpected operation pattern which is extracted from the operation history information obtained from an arbitrary operation target device on operation target devices other than the operation target device.

7. The information processing apparatus according to claim 2,
wherein the rule extraction unit extracts an operation pattern which is not registered in the defined pattern database among the operation patterns extracted by the pattern extraction unit as the unexpected operation pattern.

8. An information processing apparatus comprising:
a pattern extraction unit configured to extract an operation pattern from an operation history on the information processing apparatus by a user;
an unexpected operation pattern extraction unit configured to extract an unexpected operation pattern from the operation pattern extracted by the pattern extraction unit with reference to a defined pattern which is a pattern of a combination of defined operations on the information processing apparatus; and
a reflection information generation unit configured to generate reflection information to be reflected on a function of the information processing apparatus from the unexpected operation pattern.

9. An information processing system comprising:
operation target devices each including
an input unit to which an operation signal based on an operation by a user is input,
a signal processing unit configured to process an input signal on the basis of the operation signal which is input to the input unit, and
a history saving unit configured to store an operation history of the user and a device state after the input signal is processed, as operation history information; and
an information processing apparatus including
a pattern extraction unit configured to extract operation patterns from the operation history information at least including the operation history of the user and information on the device state obtained from the operation target devices,
a defined pattern database configured to previously register a defined pattern which is a pattern of a combination of defined operations in accordance with the operation target devices,
a rule extraction unit configured to extract an unexpected operation pattern from the operation patterns extracted by the pattern extraction unit with reference to the defined pattern database, and
a reflection information generation unit configured to generate reflection information to be reflected on a function of the operation target devices from the unexpected operation pattern.

10. An information processing method comprising the steps of:
obtaining operation history information at least including an operation history of a user and information on a device state obtained from a plurality of operation target devices;
extracting operation patterns from the operation history information;
extracting an unexpected operation pattern from the extracted operation patterns with reference to a defined pattern database previously registering a pattern of a combination of defined operations in accordance with the operation target devices; and
generating reflection information to be reflected on a function of the operation target devices from the unexpected operation pattern.
